(19) United States
(12) Patent Application Publication
(10) Pub. No.: US 2018/0201014 A1
(43) Pub. Date: Jul. 19, 2018

(54) LIQUID EJECTION APPARATUS AND METHOD FOR ADJUSTING THE SAME

(71) Applicant: MIMAKI ENGINEERING CO., LTD., Tomi-shi, Nagano (JP)

(72) Inventor: Masaru OHNISHI, Nagano (JP)

(73) Assignee: Mimaki Engineering Co., Ltd., Tomi-shi, Nagano (JP)

(21) Appl. No.: 15/743,667

(22) PCT Filed: Aug. 25, 2016
(86) PCT No.: PCT/JP2016/074769

§ 371 Date: Jan. 11, 2018

(30) Foreign Application Priority Data
Aug. 28, 2015 (JP) 2015-169720
Sep. 28, 2015 (JP) 2015-189268

(51) Int. Cl. B41J 2/045

(52) U.S. Cl. CPC B41J 2/04588; B41J 2/04581; B41J 2/04573; G02B 5/201; B41J 2/0455; B41J 2/04541; B41J 2/0456

(57) ABSTRACT

A liquid ejection apparatus to eject liquid droplets includes an inkjet head that is an ejection head including a plurality of nozzles and a plurality of driving elements, a driving signal outputter, an ejection nozzle setter, and a timing setter to set timing at which the driving elements receive a driving signal. The driving signal outputter outputs, in common, a voltage change signal being a signal whose voltage changes with passage of time, as at least a part of the driving signal, to the plurality of nozzles. The timing setter individually sets, for each of the driving elements, a time period during which the driving elements receive the voltage change signal. The nozzles respectively eject liquid droplets by inkjet technology according to the driving signal in which the time period to receive the voltage change signal is individually set.

### TECHNICAL FIELD

The invention of the present application relates to a liquid ejection apparatus and a method for adjusting the liquid ejection apparatus.

### BACKGROUND ART

Inkjet printers that carry out printing using inkjet technology have conventionally been widely used (refer to patent document 1). The inkjet printers carry out the printing by ejecting ink droplets from nozzles of inkjet heads.

### RELATED ART DOCUMENTS

### Patent Document

Patent document 1: Japanese Unexamined Patent Application Publication No. 2008-162261

### SUMMARY

### Technical Problems

Because the inkjet head is structured to eject ink droplets from a fine nozzle, it is inevitable that a certain degree of variation occurs in ejection property of ink droplets. Hence, a variety of methods for correcting the variation in the ejection property of ink droplets have conventionally been considered.

For a serial inkjet printer to perform a main scanning operation (scanning operation) of ejecting ink droplets while moving in a preset main scanning operation (Y axis direction), a method of performing printing in a multi-pass mode has conventionally been known as one of methods for correcting the ejection property variation. The multi-pass mode is a mode for carrying out a plurality of times of the main scanning operations at individual positions of a printing region of a printing target medium at which printing is carried out.

This method includes ejecting ink droplets through different portions (nozzles) of the inkjet head in the main scanning operations at the individual positions without making any correction for property on a per-nozzle basis, when the variation in ejection property of the nozzle of the inkjet head is within a fixed range. With this configuration, an identical line is subjected to mixture printing by a plurality of nozzles in the inkjet head, and therefore, the variations in ejection properties of the individual nozzles are averaged to make the variation less noticeable.

However, when printing is carried out in the multi-pass mode, printing speed decreases according to the number of passes by which the main canning operation is carried out at the individual positions of the medium, and it is therefore difficult to carry out a high speed printing. More specifically, when N is the number of passes in the multi-pass mode, the printing speed decreases to 1/N than the case of performing no printing in the multi-pass mode. Further, when printing is carried out in the multi-pass mode, influences of the variations of the nozzles are averaged to make the influences less noticeable for the purpose of observing from a remote position away from the medium. However, the influence of the nozzle property variation appears for the purpose of observing a printing result near the medium, and image quality can deteriorate. Additionally, when printed wiring or the like is printed for use in industrial fields, an adverse effect can occur in electrical properties.

As another method of correcting variation in nozzle ejection property, a method of making a correction on a per-inkjet head basis (a per-head property classification basis correction method made on a per-head basis) is conceivable. In this case, a measurement is made in terms of nozzle ejection property variation on an individual inkjet head basis, instead of on a per-nozzle basis, and center values of the variations on a per-inkjet head are classified into a plurality of stages. The variations between the heads are reduced by determining a group of heads incorporated into a printer on a per-property classification basis, or by changing, on a per-inkjet head basis, ejection conditions, such as a pulse width and a voltage of a signal (driving signal) to control ejection of ink droplets. This is not intended to correct the ejection property on a per-nozzle basis, but correct the variations in average ejection property between the inkjet heads.

With this method, however, the nozzle ejection property variations of the nozzles in the inkjet head are not correctable. It is therefore necessary to be used together with another mode, such as the multi-pass mode. This results in a similar problem as in the case of employing another mode, such as the multi-path mode.

It is conceivable in principle that, for example, a signal voltage of a driving signal to control ejection of ink droplets from the individual nozzles is changed on a per-nozzle basis. In this case, in such a configuration of controlling ejection of ink droplets from the nozzles in a push-pull mode, it is conceivable to adjust a voltage to control an operation of push or pull so that a volume of ink droplets reaches a fixed predetermined volume.

With this configuration, the ejection property of the individual nozzles are individually correctable. However, this case necessitates voltage regulator circuits for adjusting a signal voltage, the number of which corresponds to the number of nozzles. As a result, a circuit scale seems to become too large. Therefore, a practical application with this method has not conventionally been achieved.

As a configuration for an inkjet printer, a configuration for an inkjet printer (line inkjet printer) has also conventionally been known which carries out printing in line mode without causing the inkjet head to perform a main scanning operation. As a method for reducing the influence of variation in ejection properties of nozzles, a method applicable to the line inkjet printer is being considered.

For example, there has been known a method of using an inkjet head with less variation in ejection properties of nozzles, such as “Fine head” that is being developed by Canon Inc. When using this method, however, the configuration of the inkjet head becomes complicated, and it can be difficult to achieve miniaturization. In particular, it seems difficult to achieve sufficient miniaturization in the case of the inkjet head of piezoelectric technology (piezo type) to eject ink droplets using piezo elements, unlike in the case of the inkjet head of thermal mode that is employed in the “Fine head.”

Alternatively, there is being considered a method of adjusting ejection property, such as ink volume and ejection direction, in which ink viscosity is adjusted by disposing a fine heater for each nozzle so that temperatures at positions of individual nozzles differ from each other. This case, however, can involve a significant increase in costs of the inkjet head because it is necessary to newly dispose a large number of the fine heaters.

As a method of carrying out averaging of ejection property by a line inkjet printer, as by the multi-pass mode, it is possible to consider, for example, a method of making ejection variations of individual nozzles less noticeable (multi-dot arrangement averaging method) by disposing a plurality of nozzle arrays arranged in a predetermined Y axis direction with respect to individual color inkjet heads used for printing, and carrying out mixture printing on an identical line extending in the Y axis direction through the individual nozzles (a plurality of nozzles) of the nozzle arrays. This case, however, involves a significant cost increase because the nozzle arrays need to be disposed for each of the colors.

Hence, there has conventionally been a desire for a method for appropriately reducing the influence of the ejection property variations of the nozzles in the inkjet head. The invention of the present application, therefore, aims at providing a liquid ejection apparatus and a method for adjusting the liquid ejection apparatus which are capable of solving the above problems.

### Solutions to the Problems

The inventor of the present application has conducted earnest study on a method for appropriately reducing the influence of variation in ejection properties of nozzles. More specifically, the inventor of the present application has also conducted earnest study on a method for reducing the influence of the variation that may occur in a printing result to such an extent that there is no practical problem, by eliminating or decreasing the variation in the nozzles themselves, instead of averaging the variations of the nozzles.

As to a driving signal to control the ejection of ink droplets from individual nozzles, the inventor has conceived a method for adjusting an effective voltage for a signal supplied to each of driving elements, such as piezo elements, under indirect control, instead of individually directly changing a voltage applied to each of the driving elements. More specifically, the inventor has conceived, as this method, that a signal gradually changing with the passage of time is commonly used for a plurality of nozzles, and only timing at which the signal is supplied to the driving elements of the nozzles differs from nozzle to nozzle. With this configuration, the effective voltages of the signals respectively supplied to the driving elements of the individual nozzles are changeable on a per-nozzle basis. Furthermore, in this case, an amount of ejection of each nozzle is adjustable with a simpler circuit configuration than the case of adjusting a voltage of a driving signal supplied to the driving element of each nozzle by an individual regulator or the like. With this configuration, it is therefore possible to adjust the ejection property of the nozzles with a practically scaled circuit configuration.

This configuration is applicable not only to a printing apparatus (inkjet printer) that prints a two-dimensional image, but also a variety of apparatuses using inkjet heads. For example, it is conceivable to apply to a liquid ejection apparatus that performs, for example, wiring formation by ejecting ink droplets (liquid droplets) of a functional ink (liquid) from inkjet heads. It is also conceivable to apply to, for example, a formation apparatus that forms a three-dimensional object by using inkjet heads. Specifically, the invention of the present application has the following configurations in order to solve the above problems.

(Configuration 1) A liquid ejection apparatus to eject liquid droplets by inkjet technology includes: an ejection head including a plurality of nozzles, respectively, to eject liquid droplets by the inkjet technology, and a plurality of driving elements, respectively, to cause liquid droplets to be ejected from the nozzles; a driving signal outputter to output a driving signal for driving the driving elements; an ejection nozzle setter to set the nozzle that ejects liquid droplets by selecting the driving element that receives the driving signal; and a timing setter to set timing at which the driving element corresponding to the nozzle set by the ejection nozzle setter as the nozzle that ejects liquid droplets receives the driving signal. The ejection nozzle setter is capable of selecting, as the nozzle that ejects liquid droplets, a plurality of the nozzles that eject an identical volume of liquid droplets which is preset. The driving signal outputter outputs, in common, a voltage change signal being a signal whose voltage changes with passage of time, as at least a part of the driving signal, to the plurality of the nozzles that eject the identical volume of liquid droplets. The timing setter individually sets a time period during which the driving elements receive the voltage change signal, for each of the driving elements. Each of the nozzles ejects liquid droplets by the inkjet technology according to the driving signal in which a time period to receive the voltage change signal in the driving element corresponding to the nozzle is individually set.

With this configuration, an effective voltage that each of the driving elements receives based on the voltage change signal is settable on a per-nozzle basis by individually setting, for each of the driving elements, the time period during which each of the driving elements receives the voltage change signal. Thereby, the volume of liquid droplets that each of the nozzles eject according to the driving signal is individually adjustable on a per-nozzle basis.

As compared with the case where a voltage regulator circuit for adjusting the voltage of the driving signal is disposed for each nozzle, the necessary circuit configuration scale is considerably reducible. Thus, the effective voltage of the driving signal is individually settable on a per-nozzle basis with a circuit scale in a practical range. With this configuration, the influence of the variation in ejection property of the nozzles can be more appropriately reduced to a range in which no practical problem occurs.

In this configuration, the adjustment is made so that the volumes of liquid droplets are closer to each other by supplying different time periods, during which the driving element receives the voltage change signal, to the nozzles that differ from each other in volume of liquid droplets ejected upon receipt of an identical driving signal. With this configuration, the adjustment of the ejection properties of liquid droplets by way of the individual nozzles is more appropriately performable.

In this configuration, the term “a plurality of nozzles that eject a preset identical volume of liquid droplets” denotes a plurality of nozzles that ejects an identical volume of liquid droplets in terms of design volume of liquid droplets. More specifically, in such a configuration that one nozzle ejects only one kind of volume of liquid droplets, the term “an identical volume of liquid droplets” denotes the one kind of volume of liquid droplets. In such a configuration that one nozzle ejects a volume of liquid droplet selected from a plurality of kinds of volumes, as in such a configuration that permits setting of a plurality of stages of volumes, whose volume of liquid droplets differ from each other, as a volume of liquid droplets (a variable dot configuration), the term “an identical volume of liquid droplets” may be any one of these stages of volumes.

In this configuration, the voltage change signal is a signal whose voltage changes periodically. In this case, the timing setter makes setting, on a per-driving element basis, so that a voltage in any one of time periods in a cycle needs to be supplied to each of the driving elements. With this configuration, the effective voltages respectively received by the driving elements on the voltage change signal can be appropriately adjusted based on the voltage change signal.

Alternatively, the timing setter may be capable of setting a plurality of kinds of preset time periods as a time period during which the driving element receives the voltage change signal. In this case, the timing setter sets a time period during which each of the driving elements receives the voltage change signal, by selecting any one of the plurality of kinds of time periods.

Still alternatively, the timing setter may change a pulse width at which the voltage change signal is supplied to each of the driving elements. With this configuration, the effective voltage received by the driving element is appropriately changeable. This makes it possible to appropriately achieve an operation of pulse width driving voltage control mode, which changes the effective voltage of the driving signal according to the pulse width.

In this embodiment, the liquid ejection apparatus is a printing apparatus (inkjet printer) that prints a two-dimensional image. The liquid ejection apparatus may be an apparatus that performs any operation other than image printing by ejecting liquid droplets of a functional liquid. Alternatively, the liquid ejection apparatus may be, for example, an apparatus that forms conductive wring by ejecting liquid droplets of a conductive liquid. Still alternatively, the liquid ejection apparatus may be a formation apparatus that forms a three-dimensional object by ejecting liquid droplets. In this case, the liquid ejection apparatus forms a three-dimensional object by additive manufacturing, namely, by overlapping a plurality of layers formed by ejection of liquid droplets.

(Configuration 2) Each of the driving elements is a piezo element to be displaced according to the driving signal. The term “to be displaced according to the driving signal” denotes being displaced according to a voltage of the driving signal. With this configuration, the adjustment of the ejection property of liquid droplets by way of each of the nozzles is appropriately performable by setting a time period during which each of the piezo elements receives the voltage change signal.

(Configuration 3) The driving signal outputter outputs, as at least a part of the driving signal, a first pull signal that is a voltage signal causing the piezo element to be displaced so as to pull a liquid into an ink chamber of a preceding stage of the nozzle, a push signal that is a voltage signal causing the piezo element to be displaced so as to push out the liquid pulled in according to the first pull signal, and a second pull signal that is a signal causing the piezo element to be displaced so as to push back a part of the liquid pushed out of the nozzle according to the push signal. Each of the driving elements causes liquid droplets to be ejected from the corresponding nozzle by sequentially receiving the first pull signal, the push signal, and the second pull signal. The timing setter sets timing at which each of the driving elements receives the first pull signal, the push signal, and the second pull signal. The voltage change signal is at least one of the first pull signal, the push signal, and the second pull signal.

With this configuration, the individual driving elements are capable of causing the liquid droplets to be appropriately ejected from the nozzles by sequentially receiving the first pull signal, the push signal, and the second pull signal in an identical or similar manner as in the ejection of liquid droplets in well-known push-pull mode. By employing, as a voltage change signal, at least one of the first pull signal, the push signal, and the second pull signal, a liquid droplet ejection operation is individually adjustable on a per-nozzle basis. With this configuration, it is therefore possible to more appropriately adjust the ejection property of liquid droplets by way of the individual nozzles.

(Configuration 4) The liquid ejection apparatus further includes a correction data storage to store correction data used for correction for an ejection property of the nozzles. The correction data storage stores, as the correction data, timing being preset correspondingly to the ejection property of the nozzle as timing at which the driving element receives the voltage change signal, in association with the nozzle requiring a correction for the ejection property. The timing setter sets, based on the correction data, timing of supplying the voltage change signal to the driving element corresponding to the nozzle requiring the correction for the ejection property. With this configuration, ejection property adjustments to the individual nozzles are more appropriately made based on the prepared correction data.

(Configuration 5) The voltage change signal is a signal repeated in a cycle which is preset, and a signal whose voltage gradually changes in one direction according to passage of time in the cycle. As used herein, the term “signal whose voltage gradually changes in one direction according to the passage of time in the cycle” denotes a signal whose voltage gradually increases in the cycle, or a signal whose voltage gradually decreases in the cycle. In this case, the voltage may be changed stepwise at a boundary part of the cycle.

With this configuration, the voltage of the voltage change signal is more appropriately changeable. This makes it possible to more appropriately make adjustments of the ejection property of liquid droplets by way of the individual nozzles.

(Configuration 6) The voltage change signal is a saw tooth shaped wave whose voltage changes in a saw tooth shape. With this configuration, the voltage of the voltage change signal is more appropriately changeable.

(Configuration 7) The voltage change signal is a signal repeated in a cycle which is preset. The timing setter individually sets a time period during which each of the driving elements receives a signal in terms of the voltage change signal before and after polarity inversion, by inverting polarity of the voltage change signal in a middle of a cycle, and individually setting timing of inverting polarity for each of the driving elements. With this configuration, the voltage of the voltage change signal is more appropriately changeable.

(Configuration 8) An adjustment method for a liquid ejection apparatus is intended to adjust ejection property of liquid droplets in the liquid ejection apparatus according to any one of Configurations 1 to 7. The method includes adjusting ejection property of liquid droplets respectively from the nozzles by individually setting, for each of the driving elements, a time period during which the driving element receives the voltage change signal. With this configuration, the ejection property of liquid droplets from each of the nozzles is appropriately adjustable.

(Configuration 9) The method includes: previously obtaining a nozzle property data indicating ejection property of each of the nozzles by previously measuring ejection property of each of the nozzles in a case of using the driving signal as a reference which is preset; setting, as timing at which the driving element receives the voltage change signal, timing being set based on the nozzle property data, to the driving elements respectively corresponding to each of the nozzles; and individually setting, for each of the driving elements, a time period during which the driving element receives the voltage change signal, based on timing being set based on the nozzle property data. With this configuration, the ejection property of liquid droplets from each of the nozzles is more appropriately adjustable based on the previously obtained measurement results.

(Configuration 10) An operation of previously measuring ejection property of each of the nozzles in case of using the driving signal as the reference includes previously measuring ejection property of the nozzle by causing each of the nozzles to draw a straight line by using the driving signal as the reference, and measuring a line width of the straight line.

With this configuration, the volume of liquid droplets ejected from each of the nozzles is indirectly detectable by the measurement of the line width. This leads to easier and appropriate measurements of the ejection properties of the individual nozzles than the case of directly checking the volume of the liquid droplets.

The operation of causing each of the nozzles to draw the straight line may be an operation of printing substantial continuity by causing the liquid droplets to be continuously ejected from the nozzles during the main scanning operation that causes the ejection head to move in the main scanning direction (Y axis direction). On this occasion, it is preferable to perform the main scanning operation a plurality of times by using only some of the nozzles on each time in all of the nozzles of the ejection head.

In this case, it is conceivable to adjust the ejection property of the nozzle in a predetermined variation range, based on the results of the variation in the ejection property of the nozzle which is detected as the line width. On this occasion, it is conceivable to change the effective voltage received by the driving element in a direction in which the variation for each of the nozzles is reduced in the pulse width driving effective voltage control mode.

(Configuration 11) The method includes: adjusting ejection property of the nozzle in which the ejection property falls within a preset range; and making a determination that the nozzle in which the ejection property is beyond a preset range is a defective nozzle. In this case, it is conceivable to calculate a deviation from a preset center value in terms of ejection property of the nozzle, and make a correction when the deviation falls within a predetermined fixed range, and make a determination that the ejection head is defective when the deviation exceeds the fixed value.

With this configuration, for example, an appropriate correction is performable for the nozzle whose ejection property is deviated within a correctable range. This makes it possible to appropriately reduce the number of the ejection heads that become defective products. Moreover, the need for excessive corrections can be eliminated by making the determination, for example, that the nozzle whose ejection property is considerably deviated is a defective nozzle. This makes it possible to use the configuration that permits the correction only for the nozzles whose ejection property falls within a fixed range, thus leading to an appropriate correction with a simpler configuration.

As to the driving signal to control the ejection of ink droplets from the individual nozzles, the inventor has conceived to select a signal according to ejection property from a plurality of kinds of voltage signals prepared in advance, instead of adjusting the ejection property (an amount of ejection) or the like by directly changing a voltage on a per-driving element basis by using the voltage regulator circuit or the like. More specifically, the inventor has conceived, as this configuration, to classify phenomena of ejection property variation into a plurality of classes, and prepare in advance voltage signals respectively corresponding to these classes.

With this configuration, the signal voltages respectively supplied to the driving element of the individual nozzles differ from nozzle to nozzle. Furthermore, in this case, the amount of ejection of each nozzle is adjustable with a simpler configuration than the case of adjusting the voltage of the driving signal supplied to the driving element of each nozzle by an individual regulator or the like. With this configuration, it is therefore possible to adjust the ejection property of the nozzles with a practically scaled circuit configuration.

This configuration is applicable not only to a printing apparatus (inkjet printer) that prints a two-dimensional image, but also a variety of apparatuses using inkjet heads. For example, it is conceivable to apply to a liquid ejection apparatus that performs, for example, wiring formation by ejecting ink droplets (liquid droplets) of a functional ink (liquid) from an inkjet head. It is also conceivable to apply to, for example, a formation apparatus that forms a three-dimensional object by using inkjet heads. Specifically, the invention of the present application has the following configurations in order to solve the above problems.

(Configuration 12) A liquid ejection apparatus to eject liquid droplets by inkjet technology includes: an ejection head including a plurality of nozzles, respectively, to eject liquid droplets by the inkjet technology, and a plurality of driving elements, respectively, to cause liquid droplets to be ejected from the nozzles; a driving signal outputter to output a driving signal for driving the driving elements; an ejection nozzle setter to set the nozzle that ejects liquid droplets by selecting the driving element that receives the driving signal; and an ejection property storage to store ejection property of each of the nozzles. The driving signal outputter includes: a setting voltage outputter to output a plurality of setting voltage signals that are a plurality of kinds of signals being set to voltages being different from each other; and a selection voltage supplier to supply, as the driving signal, any one of the setting voltage signals to the driving element corresponding to the nozzle that ejects liquid droplets, at least partial timing of a time period during which the driving signal is supplied to the driving element. The selection voltage supplier supplies, based on ejection property of the nozzle being stored in the ejection property storage, the setting voltage signal being previously associated with ejection property of the nozzle, to the driving elements respectively corresponding to the nozzles.

With this configuration, by individually setting the setting voltage signals respectively supplied to the driving elements on a per-driving element basis, voltages respectively applied to the driving elements can be set individually on a per-driving element basis at least at partial timing of the driving signal. This makes it possible to individually adjust, on a per-nozzle basis, the volume of liquid droplets ejected from the individual nozzles according to the driving signal. With this configuration, the variation in the ejection property itself of the nozzle can be appropriately reduced without averaging the variations in the ejection properties in the multi-pass mode or the like. Thus, the influence of the variation in ejection property which may occur on printing results is appropriately reducible to a level at which no practical problem occurs.

As compared with the case where a voltage regulator circuit for adjusting the voltage of the driving signal is disposed for each nozzle, the necessary circuit configuration scale is considerably reducible. Thus, the ejection properties of the nozzles are individually adjustable on a per-nozzle basis with a circuit scale in the practical range. With this configuration, the influence of the variation in the ejection properties of the nozzles can be more appropriately reduced to a range in which no practical problem occurs.

In this configuration, the adjustment is made so that the volumes of liquid droplets are closer to each other by supplying the different setting voltage signals to the nozzles that differ from each other in volume of liquid droplets ejected upon receipt of an identical driving signal. With this configuration, the adjustment of the ejection properties of liquid droplets by way of the individual nozzles is more appropriately performable.

In this configuration, the ejection nozzle setter is capable of selecting, as a nozzle that ejects liquid droplets, a plurality of nozzles that eject a preset identical volume of liquid droplets. The term “a plurality of nozzles that eject a preset identical volume of liquid droplets” denote a plurality of nozzles that ejects an identical volume of liquid droplets in terms of design volume of liquid droplets. More specifically, in such a configuration that one nozzle ejects only one kind of volume of liquid droplets, the term “an identical volume of liquid droplets” denotes the one kind of volume of liquid droplets. In such a configuration that one nozzle ejects a volume of liquid droplet selected from a plurality of kinds of volumes, as in such a configuration that permits setting of a plurality of stages of volumes, whose volume of liquid droplets differ from each other, as a volume of liquid droplets (the variable dot configuration), the term “an identical volume of liquid droplets” may be any one of these stages of volumes of liquid droplets. In this case, the setting voltage outputter outputs, in common, a plurality of setting voltage signals to a plurality of nozzles that eject the identical volume of liquid droplets. Based on the ejection properties of the nozzles being stored in the ejection property storage, the selection voltage supplier supplies a setting voltage signal previously associated with the ejection property of the nozzle to the plurality of nozzles that eject the identical volume of liquid droplets. With this configuration, the adjustment of the ejection property of each of the nozzles is more appropriately performable.

In this embodiment, the liquid ejection apparatus is a printing apparatus (inkjet printer) that prints a two-dimensional image. The liquid ejection apparatus may be an apparatus that performs any operation other than image printing by ejecting liquid droplets of a functional liquid. Alternatively, the liquid ejection apparatus may be, for example, an apparatus that forms conductive wring by ejecting liquid droplets of a conductive liquid. Still alternatively, the liquid ejection apparatus may be a formation apparatus that forms a three-dimensional object by ejecting liquid droplets. In this case, the liquid ejection apparatus forms a three-dimensional object by additive manufacturing, namely, by overlapping a plurality of layers formed by ejection of liquid droplets.

(Configuration 13) The ejection property storage stores ejection property of each of the nozzles by classifying the ejection property into one of n-classes which is preset (n is an integer of two or more). The setting voltage outputter outputs n-kinds of the setting voltage signals respectively associated with the n-classes. The selection voltage supplier supplies the setting voltage signals being associated with the classes to the driving elements respectively corresponding to the nozzles, according to the class into which ejection property of each of the nozzles is being classified by the ejection property storage.

With this configuration, the ejection property storage is capable of more appropriately storing the ejection properties of the individual nozzles. Additionally, the selection voltage supplier is capable of more appropriately supplying each of the nozzles with the setting voltage signal according to the ejection property of the nozzle.

(Configuration 14) The setting voltage outputter outputs, as each of the setting voltage signals, fixed voltage signals being different from each other in voltage. With this configuration, the adjustment of the ejection property of each of the nozzles is more appropriately performable.

(Configuration 15) Each of the driving elements is a piezo element to be displaced according to the driving signal. The term “to be displaced according to the driving signal” denotes being displaced according to a voltage of the driving signal. With this configuration, the adjustment of the ejection property of each of the nozzles is more appropriately performable by setting, on a per-piezo element basis, the setting voltage signals respectively supplied to the piezo elements.

(Configuration 16) The driving signal outputter outputs, as at least a part of the driving signal, a first pull signal that is a voltage signal causing the piezo element to be displaced so as to pull a liquid into an ink chamber of a preceding stage of the nozzle, a push signal that is a voltage signal causing the piezo element to be displaced so as to push out the liquid pulled in according to the first signal from the nozzle, and a second pull signal that is a signal causing the piezo element to be displaced so as to push back part of the liquid pushed out of the nozzle according to the push signal. Each of the driving elements causes liquid droplets to be ejected from the nozzle corresponding to the driving element by sequentially receiving the first pull signal, the push signal, and the second pull signal. The selection voltage supplier supplies the setting voltage signal to the driving element as at least one of the first pull signal, the push signal, and the second pull signal.

With this configuration, the liquid droplets can be appropriately ejected from the nozzles by causing the individual driving elements to sequentially receive the first pull signal, the push signal, and the second pull signal in an identical or similar manner as in the ejection of liquid droplets by well-known push-pull mode. By supplying the setting voltage signal as at least one of the first pull signal, the push signal, and the second pull signal, the adjustment of the ejection property of each of the nozzles is more appropriately performable.

(Configuration 17) An adjustment method for a liquid ejection apparatus is intended to adjust ejection property of liquid droplets in the liquid ejection apparatus according to any one of Configurations 12 to 16 includes adjusting ejection property of liquid droplets respectively from the nozzles by individually setting, for each of the driving elements, the setting voltage signal supplied to each of the driving elements. With this configuration, the ejection property of liquid droplets from each of the nozzles is appropriately adjustable.

(Configuration 18) The adjustment method includes: previously measuring ejection property of each of the nozzles in a case of using the driving signal as a reference which is preset; selecting one of the setting voltage signals, according to a measured ejection property, with respect to the driving elements respectively corresponding to each of the nozzles; and supplying the setting voltage signal selected according to the measured ejection property as at least a part of the driving signal. With this configuration, the ejection property of liquid droplets from each of the nozzles is more appropriately adjustable based on the measurement results obtained in advance.

(Configuration 19) An operation of previously measuring ejection property of each of the nozzles in a case of using the driving signal as the reference includes: previously measuring ejection property of the nozzle by causing each of the nozzles to draw a straight line by using the driving signal as the reference, and measuring a line width of the straight line.

With this configuration, the volume of liquid droplets ejected from each of the nozzles is indirectly detectable by the measurement of the line width. This leads to easier and appropriate measurements of the ejection properties of the individual nozzles than the case of directly checking the volume of the liquid droplets.

The operation of causing each of the nozzles to draw the straight line may be an operation of printing substantial continuity by causing the liquid droplets to be continuously ejected from the nozzles during the main scanning operation that causes the ejection head to move in the main scanning direction (Y axis direction). On this occasion, it is preferable to perform the main scanning operation a plurality of times by using only some of the nozzles on each time in all of the nozzles of the ejection head. In this case, it is conceivable to adjust the ejection property of the nozzle in a predetermined variation range, based on the results of the variation in the ejection property of the nozzle which is detected as the line width.

(Configuration 20) The adjustment method includes: adjusting ejection property of the nozzle in which the ejection property falls within a preset range; and making a determination that the nozzle in which the ejection property is beyond a preset range is a defective nozzle. In this case, it is conceivable to calculate a deviation from a preset center value in terms of ejection property of the nozzle, and make a correction when the deviation falls within a predetermined fixed range, and make a determination that the ejection head is defective when the deviation exceeds the fixed value.

With this configuration, an appropriate correction is performable for the nozzle whose ejection property is deviated within a correctable range. This makes it possible to appropriately reduce the number of the ejection heads that become defective products. Moreover, the need for excessive corrections can be eliminated by making the determination, for example, that the nozzle whose ejection property is considerably deviated is a defective nozzle. This makes it possible to use the configuration that permits the correction only for the nozzles whose ejection property falls within a fixed range, thus leading to an appropriate correction with a simpler configuration.

### Effects of the Invention

With the invention of the present application, the influence of the variation in the ejection properties of the nozzles in the ejection head is more appropriately reducible.

### BRIEF DESCRIPTION OF THE DRAWINGS

FIG. 1 is a diagram that shows an embodiment of a liquid ejection apparatus 10 according to an embodiment of the invention of the present application, specifically, FIG. 1(a) shows an embodiment of a configuration of a main part of the liquid ejection apparatus 10, and FIG. 1(b) shows an embodiment of a configuration of an inkjet head 12 in the liquid ejection apparatus 10.

FIG. 2 is a diagram that shows an embodiment of a conventional driving signal.

FIG. 3 is a diagram that shows an embodiment of a method of ejecting ink droplets of a variety of volumes depending on a way of driving a piezo element.

FIG. 4 is a diagram that describes a measuring method (detection method) of a line width, specifically, FIG. 4(a) is a diagram that shows the configuration of the inkjet head 12 in a simplified form, and FIGS. 4(b) and 4(c) respectively show examples of a straight line serving as a line width measurement target.

FIG. 5 is a diagram that shows an example of measurement results of line width, specifically, FIG. 5(a) shows an example of measurement results of line width with respect to a plurality of straight lines drawn by nozzles 102 on an odd-numbered array, and FIG. 5(b) shows an example of measurement results of line width with respect to a plurality of straight lines drawn by nozzles 102 on an even-numbered array.

FIG. 6 is a diagram that shows an example of variation in ejection properties of nozzles.

FIG. 7 is a diagram that shows an example of driving signals used in the present embodiment.

FIG. 8 is a diagram that describes a relationship between volume of ink droplets and hitting position, specifically, FIG. 8(a) is a table that shows an example of a relationship between line width of a straight line determined depending on the volume of ink droplets, and hitting position deviation (hitting deviation), and FIG. 8(b) is a diagram that shows a relationship between line width (line diameter) and hitting deviation when ink droplets are ejected from a nozzle with normal ejection property.

FIG. 9 is a diagram that shows an example of a situation where a hitting position changes due to a change in the volume of ink droplets.

FIG. 10 is a diagram that shows an example of velocity components of ink droplets in the middle of flight.

FIG. 11 is a diagram that shows, in a simplified form, an equivalent circuit of a driving circuit to drive a piezo element 104 in an inkjet head.

FIG. 12 is a diagram that shows more specifically a configuration for supplying a driving signal to the piezo element 104.

FIG. 13 is a diagram that shows a modification of the driving signal.

FIG. 14 is a diagram that shows another modification of the driving signal.

FIG. 15 is a diagram that shows still another modification of the driving signal.

FIG. 16 is a diagram that shows an embodiment of a liquid ejection apparatus 10 according to an embodiment of the invention of the present application, specifically, FIG. 16(a) shows an embodiment of a configuration of a main part of the liquid ejection apparatus 10, and FIG. 16(b) shows an embodiment of a configuration of an inkjet head 12 in the liquid ejection apparatus 10.

FIG. 17 is a diagram that describes in more detail a correction operation in the present embodiment.

FIG. 18 is a diagram that shows, in a simplified form, an equivalent circuit of a driving circuit to drive a piezo element 104 in an inkjet head.

FIG. 19 is a diagram that shows more specifically a part of the driving circuit to supply a driving signal to the piezo element 104.

FIG. 20 is a diagram that shows a modification of the driving signal.

### DESCRIPTION OF EMBODIMENTS

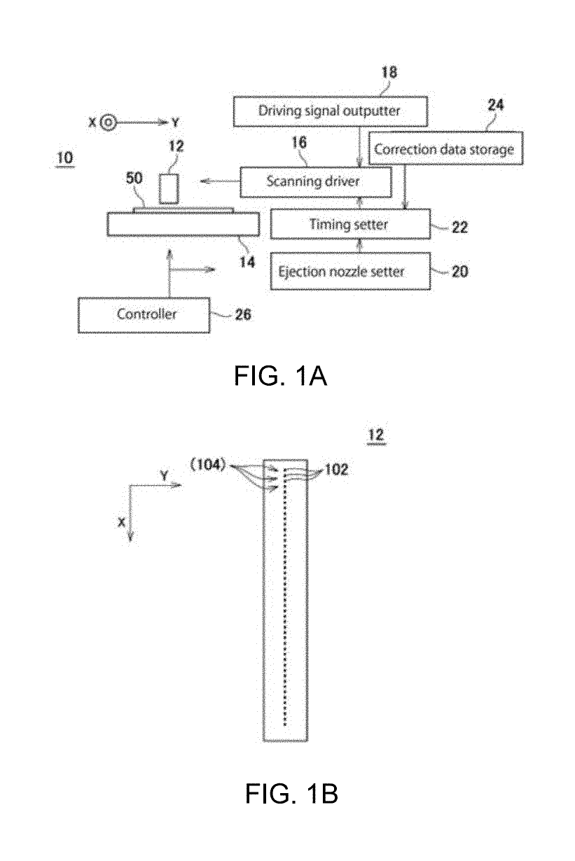

An embodiment according to the invention of the present application is described below with reference to the drawings. FIG. 1 is a diagram that shows an embodiment of a liquid ejection apparatus 10 according to an embodiment of the invention of the present application. FIG. 1(a) shows an embodiment of a configuration of a main part of the liquid ejection apparatus 10. FIG. 1(b) shows an embodiment of a configuration of an inkjet head 12 in the liquid ejection apparatus 10.

In this embodiment, the liquid ejection apparatus 10 is a printing apparatus (inkjet printer) that carries out printing by inkjet technology, and prints a two-dimensional image by ejecting ink droplets onto a medium 50 as a printing target medium. In this case, the ink droplets are an example of liquid droplets ejected by the inkjet technology. The liquid ejection apparatus 10 may have characteristic features similar or identical to those in a well-known inkjet printer, except for points described as follows. Alternatively, the liquid ejection apparatus 10 may include, besides illustrated configurations, various configurations necessary for printing operations. For example, the liquid ejection apparatus 10 may further include means for fixing ink onto the medium 50 according to a kind of ink used.

In this embodiment, the liquid ejection apparatus 10 includes an inkjet head 12, a platen 14, a scanning driver 16, a driving signal outputter 18, an ejection nozzle setter 20, a timing setter 22, a correction data storage 24, and a controller 26. The inkjet head 12 is an embodiment of ejection heads that eject liquid droplets by the inkjet technology. A well-known inkjet head is suitably usable as the inkjet head 12.

In this embodiment, the inkjet head 12 is an inkjet head that ejects ink droplets by piezoelectric technology. The inkjet head 12 includes a plurality of nozzles 102 that respectively eject ink droplets by the inkjet technology, and a plurality of piezo elements 104 that cause the ink droplets to be respectively ejected from the nozzles 102. In this case, the nozzles 102 constitute a nozzle array by being arranged in a predetermined nozzle array direction (X direction in the diagram) as shown in FIG. 1(b). The piezo elements 104 are respectively disposed at positions corresponding the nozzles 102 in the interior of the inkjet head 12. The piezo elements 104 are an example of driving elements, and cause ink droplets to be ejected from the corresponding nozzles 102 by being displaced according to the driving signal received through the scanning driver 16 from the driving signal outputter 18.

Although not illustrated, the inkjet head 12 further includes, for example, ink chambers (pressure chambers) that store ink before and after the nozzle 102. In this case, each of the piezo elements 104 causes ink to be ejected from the nozzle 102 by compressively ejecting the ink in the ink chamber due to displacement. The operation of causing the ink to be ejected from the nozzle 102 according to the driving signal is described in more detail later.

For sake of simplicity, FIG. 1(a) illustrates only one inkjet head 12 as the configuration of the liquid ejection apparatus 10. Alternatively, the liquid ejection apparatus 10 may include a plurality of the inkjet heads 12. In this case, it is conceivable to include the inkjet heads 12 that eject ink droplets of colors different from each other.

The platen 14 is a platform-shaped member to hold the medium 50, and mounts the medium 50 at a position opposite to the inkjet head 12 on an upper surface of the platen 14. The scanning driver 16 is a driver that causes the inkjet head 12 to move relative to the medium 50. In this embodiment, the scanning driver 16 causes the inkjet head 12 to perform a main scanning operation of ejecting ink droplets while moving in a preset main scanning direction (Y direction in the diagram) by causing the inkjet head 12 to move in the main scanning direction while supplying the driving signal received from the driving signal outputter 18 to the inkjet head 12. The scanning driver 16 also causes the inkjet head 12 to perform a sub-scanning operation by causing, between the main scanning operations, the inkjet head 12 to move relative to the medium 50 in a sub-scanning direction (X direction in the diagram) orthogonal to the main scanning direction. As used herein, the term “sub-scanning operation” denotes an operation of changing a position in the medium 50 which is opposed to the inkjet head 12.

The driving signal outputter 18 is a signal outputter to output a driving signal that drives the piezo elements 104. In this embodiment, the driving signal outputter 18 supplies, through the scanning driver 16, the driving signal to each of the piezo elements 104 of the inkjet head 12. The driving signal used in this embodiment is described in more detail later.

The ejection nozzle setter 20 selects the piezo element 104 that receives the driving signal in the inkjet head 12. In this embodiment, the ejection nozzle setter 20 selects the piezo element 104 that receives the driving signal, according to a position of a pixel onto which ink droplets needs to be ejected, based on image data indicating an image to be printed, for each timing of ejecting ink droplets in the main scanning operation. Thus, the nozzle 102 that ejects ink droplets is set based on the image data.

Alternatively, the ejection nozzle setter 20 may transmit a signal indicating the selected piezo element 104 through the timing setter 22 to the scanning driver 16. Thus, the scanning driver 16 supplies the driving signal received from the driving signal outputter 18, to the piezo element 104 being selected by the ejection nozzle setter 20.

The timing setter 22 sets timing at which each of the piezo elements 104 receives the driving signal. In this case, the timing setter 22 sets at least timing, at which the piezo element 104 corresponding to the nozzle 102 being set by the ejection nozzle setter 20 as the nozzle 102 to eject ink droplets, receives the driving signal.

Alternatively, the timing setter 22 may transmit a signal indicating the set timing to the scanning driver 16. Accordingly, based on the timing being set by the timing setter 22, the scanning driver 16 supplies the driving signal to each of the piezo elements 104. In this embodiment, based on the correction data being stored in the correction data storage 24, the timing setter 22 also sets timing at which each of the piezo elements 104 receives the driving signal. As used herein, the term “correction data being stored in the correction data storage 24” are data for use in correction for ejection property of the nozzles 102. The setting of the timing by the timing setter 22 is described in more detail later.

The correction data storage 24 is a storage to store correction data. In this embodiment, the correction data storage 24 stores, as the correction data, tuning at which the piezo element 104 receives a voltage change signal with respect to the nozzle 102 that needs correction for the ejection property. As this timing, more specifically, the correction data storage 24 stores timing being preset correspondingly to the ejection property of each of the nozzles 102.

The controller 26 controls operations of individual elements of the liquid ejection apparatus 10. The controller 26 may be a CPU of the liquid ejection apparatus 10. With this embodiment, for example, a printing operation to the medium 50 is appropriately performable.

The embodiment of the configuration of the liquid ejection apparatus 10 has described above by referring to the case where the liquid ejection apparatus 10 is the printing apparatus. Whereas in a modification of the configuration of the liquid ejection apparatus 10, the liquid ejection apparatus 10 may be an apparatus other than the inkjet printer. For example, the liquid ejection apparatus 10 may be any apparatus that performs an operation other than image printing by ejecting liquid droplets of a functional liquid. More specifically, in this case, the liquid ejection apparatus 10 may be, for example, any apparatus that forms conductive wring by ejecting liquid droplets of a conductive liquid. Alternatively, the liquid ejection apparatus 10 may be a formation apparatus that forms a three-dimensional object by ejecting liquid droplets. In this case, the liquid ejection apparatus 10 forms the three-dimensional object by additive manufacturing, namely, by overlapping a plurality of layers formed by ejection of liquid droplets. In these cases, the liquid ejection apparatus 10 may further include a variety of configurations according to the purpose of use. The individual elements described above may have characteristic features suitably changed according to the purpose of use.

The individual elements, such as the scanning driver 16, the driving signal outputter 18, the ejection nozzle setter 20, the timing setter 22, and the correction data storage 24, in the liquid ejection apparatus 10 have been described above, each of which is the configuration disposed outside the inkjet head 12. Alternatively, all or some of these elements may be disposed inside the inkjet head 12.

Subsequently, the driving signals used in this embodiment and the setting of timing by the timing setter 22 are described in more detail below. For the sake of description, an example of driving signals that have been used in the conventional configuration is described first.

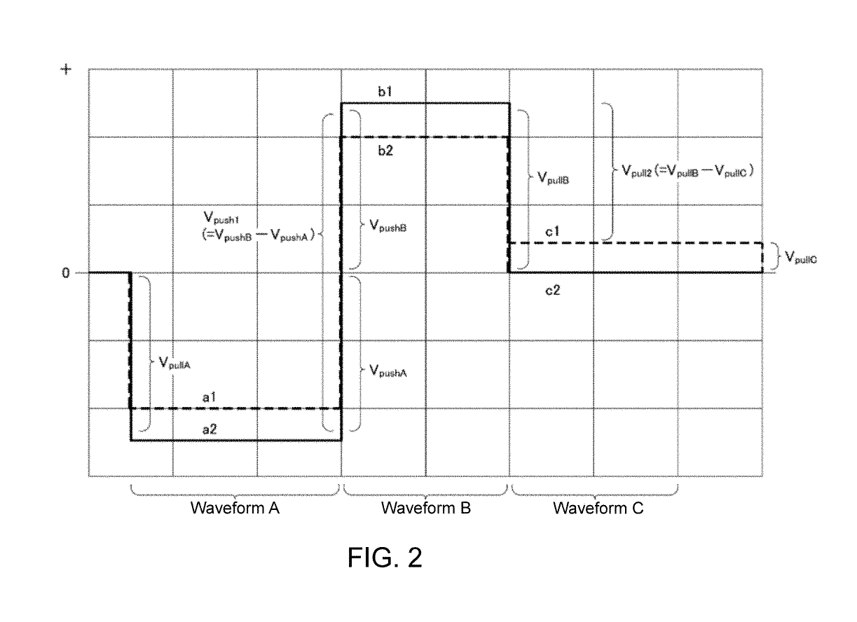

FIG. 2 is a diagram that shows the example of the conventional driving signals by modeling a waveform of a principled driving signal (driving voltage) when ink droplets are ejected by an operation made up of three stages of pull, push, and pull in a piezo inkjet head. This operation is a well-known push-pull mode operation and made up of four modes: an operation mode of pulling ink into the ink chamber (“pull 1 mode”); an operation mode of pushing the ink from the ink chamber through the nozzle to the outside (“push mode”); an operation mode of quickly pulling back the piezo element being deformed in the push mode (“pull 2 mode”); and a standby mode of holding piezoelectric displacement constant by applying a direct voltage including zero. In this case, a voltage that retains constant and unchanged over a longer period of time than a cycle corresponding to acoustic resonance frequency of the inkjet head is used as the direct voltage including zero.

In FIG. 2, a centerline in a lateral direction denotes zero, a zone above the centerline denotes positive voltage, and a zone below the centerline denotes negative voltage. More specifically, in the illustrated case, a driving signal supplied to the piezo element corresponding to the nozzle that ejects ink droplets is made up of three waveform segments of a waveform A, a waveform B, and a waveform C.

For the sake of simplicity in the following description, pulses constituting the driving signal are indicated by rectangular waves, all of which change instantly. However, in an actual configuration, a voltage change needs to be completed in a shorter time than an acoustic resonance frequency cycle of the inkjet head. Therefore, a waveform that changes with time and has dull rising and falling may be used.

When using the driving signal having the waveforms shown in FIG. 2, the piezo element is displaced in a direction in which the ink chamber is enlarged and expanded during the pull 1 mode carried out according to the waveform A. Due to the expansion, the ink is pulled in and loaded through an ink supply channel (not shown) into the ink chamber. On this occasion, an amount of deflection of the piezo element increase approximately in proportion to an applied voltage V_{pullA}.

This pull-in operation is preferably carried out so as not to break down a meniscus formed by the ink at the position of the nozzle. More specifically, on this occasion, the pull-in operation is preferably carried out slowly to such an extent that an increase in negative pressure in the ink chamber is suppressible by the supply of the ink so as to ensure that a negative pressure defined by a pressure difference with respect to atmospheric pressure does not exceed several hundredths of atmospheric pressure.

This pull-in operation is followed by the push operation (push mode) carried out according to the waveform B. This push operation is an operation of pushing out the ink from the nozzle at one push. In this case, an amount of pushing the ink is a total value of an amount of pull-in and an amount of push-out. Accordingly, a volume of ink droplets (ink volume) ejected approximately in proportion to Vₚᵤₛₕ₁ being equal to V_{pushB}-V_{pullA} is determined in the illustrated case. In other words, when using the driving signal shown in FIG. 2, V_{pullA} (=V_{pushA}) is changed by selecting either one of waveforms a₁ and a₂ as the waveform A, or V_{pushB} is changed by selecting either one of waveforms b₁ and b₂ as the waveform B. By doing so, the amount of ink pushed out by a change in either one of V_{pullA} and V_{pullB} is changed, so that the volume (size) of the ink droplets ejected from the nozzle is changed.

The push operation is followed by an operation of “pull 2 mode” carried out according to the waveform C. This operation is intended to decrease voltage as in examples respectively indicated as C₁ and C₂ in a pull direction in which the ink is pulled in. In this case, when it is desired to decrease the amount of ink ejected, a pull voltage variation is decreased as in the example C₁. Consequently, the ink moving in an ejection direction is subjected to a small force in a pull-back direction. When it is desired to increase the amount of ink ejected, a pull voltage variation is increased as in the example C₂. Consequently, the ink moving in the ejection direction is subjected to a large force in the pull-back direction. The volume (amount of ejection) of ink droplets is therefore also changeable by making the voltages of the waveform C different from each other.

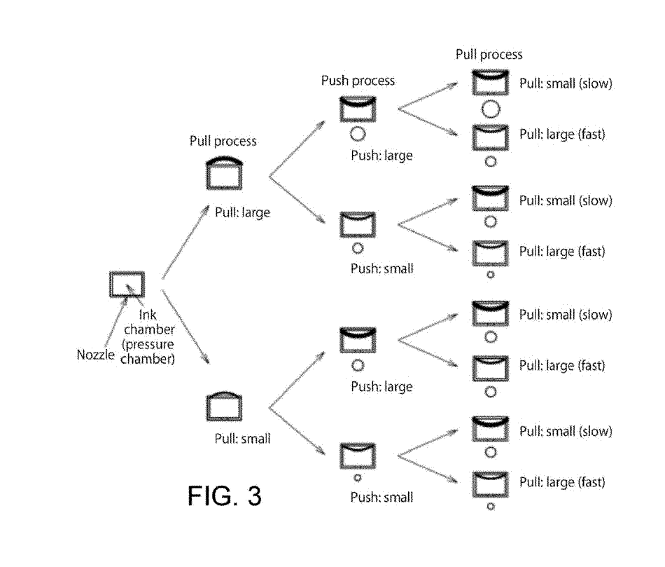

Thus, even when using the conventional driving signal, the volume of the ink droplets is changeable by changing the voltage of each of the waveforms A, B, and C. FIG. 3 shows an embodiment of a method of ejecting different volumes of ink droplets depending on the way of driving the piezo element.

As described with reference to FIG. 2, when using the conventional driving signal, the volume of ink droplets is variously changeable by changing any one of a voltage in the “pull 1 mode” (V_{pullA}=V_{pushA}), a voltage in the push mode (Vₚᵤₛₕ₁=V_{pushB}−V_{pushA}), and a voltage in the “pull 2 mode” (Vₚᵤₗₗ₂=V_{pullB}−V_{pullC}). In FIG. 3, the changes in the volume of ink droplets (ink droplet size) made in this manner are shown by modeling.

As seen from this diagram, a volume of ink droplets ejected from each of the nozzles is controllable as long as the voltages in the “pull 1 mode,” “push mode,” and “pull 2 mode” are controllable with respect to each of the piezo elements. This makes it possible to make, for example, a correction for the amount of ejection so that the volume of ink droplets reaches a predetermined fixed value, even in the presence of a nozzle whose volume of ink droplets ejected deviates from that of a standard nozzle.

When using the conventional driving signal, for example, a voltage regulator circuit needs to be disposed for each of the individual nozzles in order to make the above correction. It is therefore difficult to achieve this control with a practical circuit scale.

Whereas in this embodiment, the volume of ink droplets or the like is corrected with a smaller practical circuit scale by using the driving signal different from the conventional one, and controlling the timing of supplying the driving signal to each of the piezo elements 104. This is described in more detail below. A measurement operation and the like carried out prior to the correction is described firstly.

As described earlier, in this embodiment, the timing setter 22 (refer to FIG. 1) sets timing at which each of the piezo elements 104 (refer to FIG. 1) receives the driving signal, based on the correction data being stored in the correction data storage 24 (refer to FIG. 1). The correction data storage 24 stores, as correction data, data for use in the correction for the ejection property of the nozzles 102.

A measurement for obtaining the ejection property of the individual nozzles 102 (refer to FIG. 1) in the inkjet head 12 is carried out in this embodiment in order to make adjustment of the timing. More specifically, in this case, nozzle property data indicating the ejection property of the individual nozzles 102 are previously obtained by previously measuring the ejection property of the individual nozzles 102 when a preset reference driving signal. Based on the obtained nozzle property data, necessary correction data are created and stored in the correction data storage 24.

As to the operation of previously measuring the ejection property of the nozzles 102 when using the reference driving signal, more specifically, it is conceivable to measure the ejection property of each of the nozzles 102 by causing the nozzle 102 to draw a straight line with the use of the reference driving signal, and then measuring a line width of the straight line. With this configuration, the volume of ink droplets ejected from each of the nozzles 102 is indirectly detectable by the measurement of the line width. This leads to easier and appropriate measurement of the ejection property of the individual nozzles 102 than the case of directly checking the volume of the ink droplets. The operation of measuring the ejection property of the nozzles 102 by the measurement of the line width is described below.

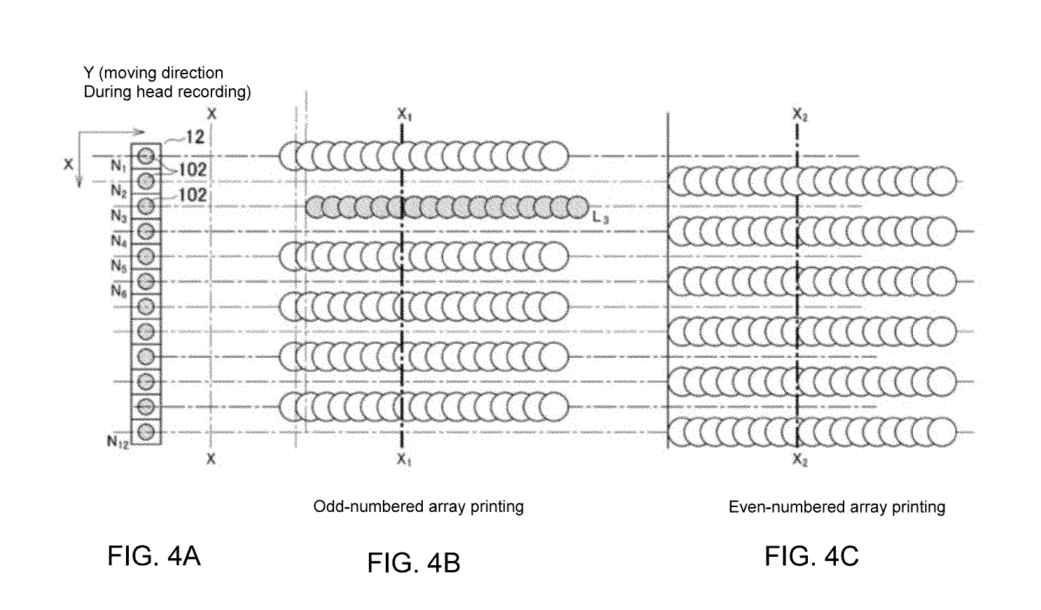

FIG. 4 is a diagram that describes a line width measuring method (detection method), and shows an example of a method of detecting a volume of ink droplets based on a measured line width. FIG. 4(a) is a diagram that shows a configuration of the inkjet head 12 in a simplified form.

For the sake of easier description, the following description is given of an operation in the case of using an inkjet head 12 in which twelve nozzles 102 indicated as N to N₁₂ in the diagram are arranged in the sub-scanning direction (X direction). This inkjet head 12 is a high resolution head in which a small number of nozzles 102 are arranged at a pitch of 600 dpi (dots per inch) (a nozzle array resolution pitch) in the sub-scanning direction. In this case, the pitch in the sub-scanning direction may be a pitch between the nozzles 102 being projected onto a straight line extending in the sub-scanning direction. Therefore, the nozzles 102 may be arranged in an oblique direction intersecting with the sub-scanning direction, or alternatively arranged in a zig-zag structure.

Detecting the volume of ink droplets based on the line width may denote detecting a dot size of a printed ink. Alternatively, the operation of detecting the bit size based on the line width may be carried out with a well-known method. Hence, the following description focuses on characteristic parts in this embodiment.

A dot size of ink formed on a medium by ink droplets is usually determined according to various conditions of printing (printing conditions). Conceivable examples of these conditions include printing resolution, moving velocity of the inkjet head during the main scanning operation, the kind of a medium used, ink used, and environmental temperature. It is conceivable that when these conditions are stable, a relationship between a volume of ink droplets and a width of a straight line drawn is uniquely determined. It is therefore conceivable that the volume of ink droplets is identical as long as the value of a line width is identical without the need for a direct measurement of the volume of ink droplets which is difficult to measure. Thus in this embodiment, this relationship is used to make a correction for the ejection property of the nozzles 102.

FIGS. 4(b) and 4(c) respectively show examples of a straight line that becomes a measuring object of a line width. This embodiment causes inkjet head 12 to eject ink droplets so that ink dots are continuously arranged in the main scanning direction, while causing the inkjet head 12 having the configuration shown in FIG. 4(a) to move in the main scanning direction (Y direction). In this case, the pitch of the ink dots in the main scanning direction is set to a pitch (for example, 1200 dpi) smaller than the nozzle pitch in the sub-scanning direction. This also causes at least some of the nozzles 102 in the inkjet head 12 to draw a straight line (continuous line) extending in the main scanning direction. In this case, the operation of causing each of the nozzles 102 to draw the straight line may be an operation of printing substantial continuity by causing the ink droplets to be continuously ejected from the nozzles 102 during the main scanning operation that causes the inkjet head 12 to move in the main scanning direction (Y axis direction).

On this occasion, it is preferable to perform the main scanning operation a plurality of times by using only some of the nozzles on each time in all of the nozzles 102 of the inkjet head 12. More specifically, on this occasion, it is preferable to avoid contact between the straight lines adjacent to each other in the sub-scanning direction by avoiding simultaneous selection of the nozzles 102 continuously arranged in the sub-scanning direction in the nozzles 102 that draw a straight line. In this case, it is also preferable to perform a plurality of times of the operation of causing the nozzles 102 to draw the straight line while changing the nozzles 102 selected so that all of the drawn straight lines are measurable in all of the nozzles 102 in the inkjet head 12.

FIGS. 4(b) and 4(c) respectively show the cases where the operation of drawing the straight line is divided into two by dividing the nozzles 102 into two groups of the odd-numbered nozzles 102 (odd-numbered arrays) and even-numbered nozzles 12 (even-numbered arrays) when numbered from one end side of a nozzle array of the inkjet head 12. FIG. 4(b) shows the case including a line drawn by the nozzle 102 causing failure (abnormal ejection) in which the volume of ink droplets decreases. More specifically, the nozzle 102 causing the failure corresponds to the third nozzle 102 (nozzle N₃) from the top in the configuration shown in FIG. 4(a).

When the ink dot is further larger than the nozzle pitch in the inkjet head 12, it is conceivable to draw a straight line extending in the main scanning direction by all of the nozzles 102 by selecting the nozzle 102 while leaving space for two nozzles or “n” nozzles (n is an integer of three or more), and by performing the operation of drawing a straight line by dividing the operation into three or (n+1). With this configuration, the straight line is drawable more appropriately by all of the nozzles while preventing, for example, connection and contact between the lines in the sub-scanning direction.

After drawing the straight line by the individual nozzles 102, the line width measurement (detection) is carried out. On this occasion, it is conceivable to measure optical reflective light intensity and concentration distribution at a predetermined position with respect to the drawn straight line. More specifically, it is conceivable to measure the optical reflective light intensity or concentration distribution in the sub-scanning direction with respect to a plurality of straight lines drawn by the nozzles 102 of the odd-numbered arrays shown in FIG. 4(a) at a position indicated by line X₁-X₁ in the diagram. On this occasion, it is conceivable to use a reflective light distribution measurement method by means of a laser optical scanning, linear image sensor, or two-dimensional image sensor. This measurement may be made by an optical reading means incorporated in the liquid ejection apparatus 10 (refer to FIG. 1), or by an external device, such as an image scanner or drum scanner. It is also conceivable to make a similar measurement at a position indicated by line X₂-X₂ in the diagram with respect to a plurality of straight lines drawn by the nozzles 102 of the even-numbered arrays shown in FIG. 4(b).

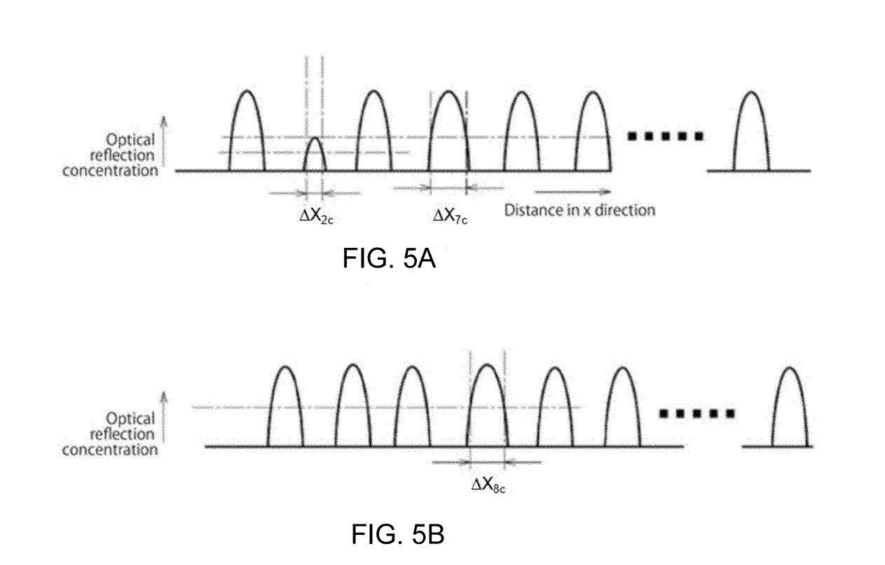

FIG. 5 is a diagram that shows an example of measurement results of line widths, and shows an optical reflection concentration curve detected by the method described above. FIG. 5(a) shows an example of measurement results of line widths with respect to a plurality of straight lines drawn by the nozzles 102 of the odd-numbered arrays. FIG. 5(b) shows an example of measurement results of line widths with respect to a plurality of straight lines drawn by the nozzles 102 of the even-numbered arrays. A vertical axis in FIGS. 5(a) and 5(b) indicates relative printing concentration.

As described above, FIG. 4(b) shows the case including the line drawn by the nozzle 102 (nozzle N₃) causing failure (abnormal ejection) in which the volume of ink droplets decreases. All of other nozzles 102 are normal. Therefore, a reflective concentration peak that indicates the measurement result corresponding to the line (printed line L₃) drawn by the nozzle 102 (nozzle N₃) of abnormal ejection is small in FIG. 5(a). Accordingly, the measurement result of the line width (ΔX_{2c}) is different from the measurement result (e.g., ΔX_{7c}) on other nozzles 102 being normal. Therefore, the measurement results of an optical reflection concentration distribution curve shows that the nozzle 102 not ejecting a sufficient amount of ink is short of an optical reflection concentration as compared with the other nozzles 102 being normal.

In the line width measurement, more specifically, the line width of the straight line drawn by each of the nozzles 102 is detected based on, for example, a fixed threshold value level, and a position of a half-value width of each waveform shown in the diagram, from a distribution curve for each of the nozzles 102. A determination is made that the volume of ink droplets is beyond a normal range when the detected line width exceeds or falls below a predetermined value. With this configuration, the ejection properties of the individual nozzles 102 are measurable easily and appropriately.

In this embodiment, a correction for ejection property is additionally made on at least a part of the nozzles 102 whose volume of ink droplets is beyond the normal range. This leads to a correction for an ink dot size formed by each of the nozzles 102.

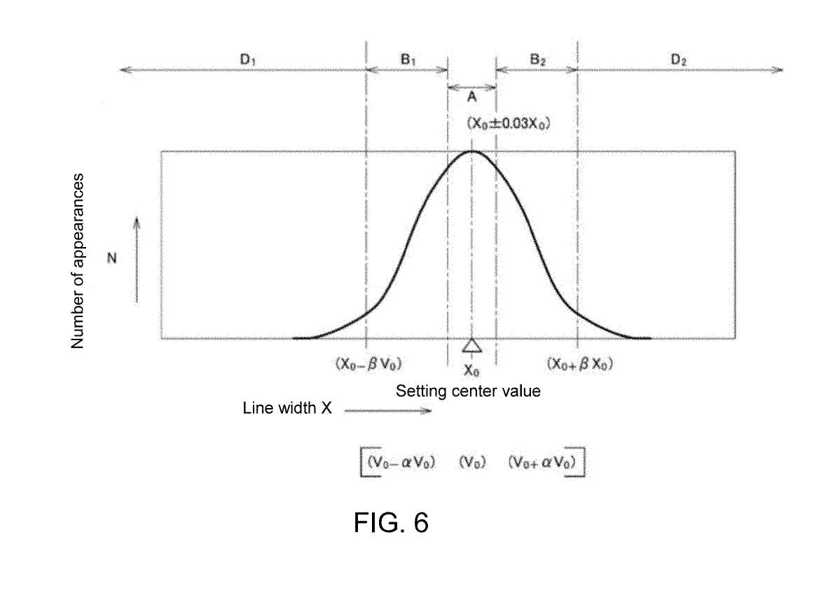

FIG. 6 shows an example of variations in ejection properties of nozzles. The piezo inkjet head, which causes the piezo element 104 (refer to FIG. 1) to eject ink droplets from the nozzles 102, as in this embodiment, is subject to variations in mechanical structure and material due to processing accuracy of the piezo element 104, or mechanical variations in the nozzles and the ink chambers. Consequently, even when the piezo elements 104 are driven under identical driving conditions, the volume of ink droplets ejected from the nozzles may vary around a center value of a designed ejection value (ejection center ejection amount V₀). Further, a line width drawn by each of the nozzles may also vary around the center value X₀ of the line width along with the variation in volume of ink droplets.

FIG. 6 shows line widths drawn by the individual nozzles of each of a large number of the inkjet heads, in which a horizontal axis indicates a detected line width, and a vertical axis indicates the number of appeared nozzles. In the case shown, a situation is shown in which the ejection amount (line width) varies around the line width X₀ corresponding to the ejection center ejection amount in an approximately normal distribution.

In an actual inkjet head, the variation in ejection properties of the nozzles often deviates from the normal distribution. However, because there is no obstacle to description of the principle of correction for the ejection property, the foregoing and the following describe the case where the variation has the normal distribution.

In order that a beautiful image free from stripe unevenness that can occur due to the variation in the nozzles is printed by one main scanning operation (1 pass), the volume of ink droplets ejected from the nozzles usually needs to be held constant. More specifically, It has been confirmed experimentally in order to achieve a high quality printing, it is necessary to fall within a variation range of ±3% or less (0.97X₀ to 1.03X₀) with respect to the center value of the volume (ejection amount) that becomes the center value X₀ of the line width as indicated by a range A in FIG. 6. On this occasion, it seems preferable that the corresponding ejection amount also falls within the variation range or less with respect to the center value.

In the actual inkjet head, however, a large number of the nozzles show the variation in the volume of ink droplets which exceeds ±5% as shown in FIG. 6. With the situation as it is, a stripe or the like appears in the scanning direction of the nozzles, resulting in significant deterioration of image quality. It is consequently difficult to use in a printing operation by 1 pass or a smaller number of passes. When only the heads with less variation are selected and used, a failure rate of the inkjet heads in the inkjet heads having such a variation may be extremely as high as 90% or more, thus leading to a significant cost increase.

Therefore, in order to decrease the failure rate (approximately 5% or less) by relieving the inkjet head that becomes a defective product as it is, it is desired to make a correction for the ejection property so that at least the inkjet heads having the nozzle in ranges respectively indicated as ranges B1 and B2 become a good product in the case shown in FIG. 6. In this case, it becomes necessary to relieve, by correction, the inkjet head subjected to variation of at least approximately 20% in the volume (or weight) of ink droplets.

On this occasion, when an attempt is made to correct even the nozzle whose ejection property deviates greatly from the standard, a configuration for correction becomes complicated, and the correction may not be made appropriately. It is therefore preferable to adjust the ejection property of only the nozzles whose ejection property falls within a preset range. On this occasion, a determination may be made that the nozzle whose ejection property is beyond the range is a defective nozzle. As used herein, the term “nozzle beyond the range” denotes the nozzles lying in the ranges indicated as D1 and D2 in the diagram. A similar determination may be made that the inkjet head having such a defective nozzle is a defective inkjet head. More specifically, the following is conceivable. That is, by calculating a deviation of the ejection property of the nozzle from the preset center value, a correction is made when the deviation falls within a predetermined fixed value, and a discrimination is made that exceeding the fixed value indicates defective ejection and defective inkjet head.

With this configuration, a more appropriate correction is performable for the nozzle whose ejection property is deviated within a correctable range. This makes it possible to appropriately reduce the number of the inkjet heads that become defective products. Moreover, the need for excessive corrections can be eliminated by making the determination, for example, that the nozzle whose ejection property is considerably deviated is a defective nozzle. This makes it possible to use the configuration that permits the correction only for the nozzles whose ejection property falls within the fixed range, thus leading to an appropriate correction with a simpler configuration.

The operation of correcting the ejection property in this embodiment is described in more detail below. As to matters associated with the operation of correcting the ejection property, a relationship between variation in volume of ink droplets and a deviation in hitting position is described first. As described earlier, with this embodiment, the volume of droplets ejected from each of the nozzles is individually adjustable on a per-nozzle basis by using the plurality of setting voltage signals. As to the variation in ejection property of the nozzles, however, it is desirable to also consider the variation in hitting position, besides the volume of ink droplets. In this regard, the variation in hitting position of ink droplets is not irrelevant to the variation in volume of ink droplets, but there is usually a correlation between the two.

More specifically, when a voltage of a driving signal supplied to the piezo element corresponding to the normal nozzle is appropriate, a diameter of a dot of ink formed has a size within a predetermined range according to a resolution pitch. Thus, when a straight line is drawn by the normal nozzle, the straight line with a line width within a predetermined normal range is drawable. A hitting position corresponds to a predetermined position being set according to a resolution (a set center position).

Meanwhile, when a voltage of the driving signal is changed, the diameter of the dot of the ink and the hitting position change according to the voltage of the driving signal. In the case where the voltage of the driving signal is lowered so as to apply an undervoltage, the volume of ink droplets (liquid droplet volume) decreases, and a line width drawn becomes narrow. The hitting position is susceptible to influence of air resistance due to a decrease in the liquid droplet volume, so that the hitting position is increased in a plus direction from a center setting position. As used herein, the term “plus direction” denotes a direction when a moving direction of the inkjet head during ejection of ink droplets is defined as plus. In contrast, in the case where the voltage of the driving signal is increased so as to apply an overvoltage, the volume of ink droplets increases, and a line width drawn becomes wide. The hitting position is less susceptible to the influence of air resistance due to an increase in the liquid droplet volume, so that the hitting position is decreased in a minus direction from the center setting position. Thus, the influence of the air resistance exerted on the ink droplets changes depending on the volume of the ink droplets. Consequently, the amount of deviation in a hitting position also changes depending on the volume of the ink droplets.

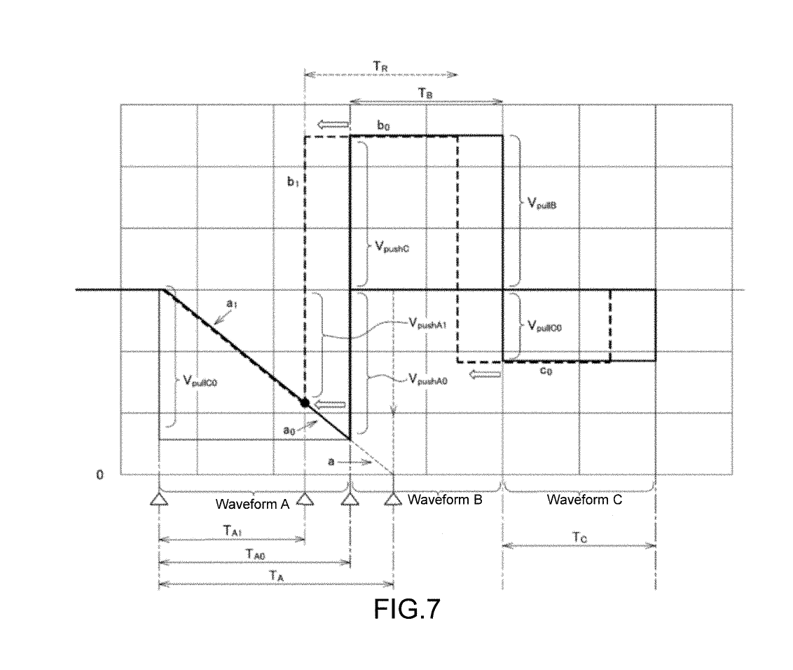

FIG. 7 is a diagram that shows an embodiment of the driving signals used in this embodiment, specifically, an embodiment of the driving signals when ink droplets are ejected from the nozzles in the pull-push-pull mode. In a manner basically similar to the case shown by way of modeling with reference to FIG. 2 or the like, this embodiment controls the amount of ejection of ink droplets from each of the nozzles in the configuration using the piezo inkjet head, by using the driving signal obtainable by combining a waveform (waveform A) for a pull operation of pulling ink into the ink chamber by a voltage application to the piezo element, a waveform (waveform B) for a push operation of pushing out ink from the ink chamber, and a waveform (waveform C) for a pull operation of pulling back the ink into the ink chamber.

In this case, a segment of the waveform A in the driving signal is an embodiment of a first pull signal that is a voltage signal causing the piezo element to be displaced so as to pull a liquid (ink) into the ink chamber of the preceding stage of the nozzle. A segment of the waveform B is an embodiment of a push signal that is a voltage signal causing the piezo element to be displaced so as to push out the liquid pulled in according to the first pull signal. A segment of the waveform C is an embodiment of a second pull signal that is a signal causing the piezo element to be displaced so as to push back part of the liquid pushed out of the nozzle according to the push signal. On this occasion, the driving signal outputter 18 (refer to FIG. 1) outputs the first pull signal, the push signal, and the second pull signal as at least a part of the driving signal in the liquid ejection apparatus 10 (refer to FIG. 1). The timing setter 22 (refer to FIG. 1) sets timing at which each of the piezo elements receives the first pull signal, the push signal, and the second pull signal. Then, the piezo elements cause ink droplets to be ejected from their respective corresponding nozzles by sequentially receiving the first pull signal, the push signal, and the second pull signal.

As seen in the diagram, in this embodiment, the driving signal outputter 18 outputs, as at least a part of the driving signal, a voltage change signal that is a signal whose voltage changes with passage of time. More specifically, the first pull signal corresponding to the waveform A serves as the voltage change signal in the case shown in the diagram.

The driving signal shown in FIG. 7 is a driving signal intended to cause ejection of a predetermined volume of ink droplets which is preset in the liquid ejection apparatus 10. On this occasion, the ejection nozzle setter 20 may select, as a nozzle that ejects ink droplets according to the driving signal, a plurality of nozzles that eject an identical volume of liquid droplets based on image data that indicates an image to be printed. The driving signal outputter 18 outputs, in common, a driving signal including the voltage change signal to these nozzles.

As used herein, the term “a plurality of nozzles that eject an identical volume of liquid droplets” denotes a plurality of nozzles that eject an identical volume of liquid droplets in terms of design volume of liquid droplets. More specifically, in such a configuration that one nozzle ejects only one kind of volume of liquid droplets, the term “an identical volume of liquid droplets” denotes the one kind of volume of liquid droplets. In such a configuration that one nozzle ejects a volume of liquid droplet selected from a plurality of kinds of volumes, as in such a configuration that permits setting of a plurality of stages of volumes, whose volume of liquid droplets differ from each other, as a volume of liquid droplets (a variable dot configuration), the term “an identical volume of liquid droplets” may be any one of these stages of volumes.

In this embodiment, the timing setter 22 individually sets a time period during which the piezo elements receive the voltage change signal (waveform A, the first pull signal) on a per-piezo element basis. Each of the nozzles ejects liquid droplets by inkjet technology according to the driving signal intended to individually set the time period during which the corresponding piezo element receives the voltage change signal.

More specifically, on this occasion, the timing setter 22 sets timing at which the piezo element receives the voltage change signal, with respect to the piezo elements respectively corresponding to the individual nozzles. Specifically, based on the correction data being stored in the correction storage 24, the timing setter 22 sets timing at which the piezo element corresponding to the nozzle requiring a correction for the ejection property receives the voltage change signal. Thus, the timing (time period) in which the individual piezo elements receive the voltage change signal are individually set on a per-piezo element basis, based on the nozzle property data previously obtained by the line width measurement or the like. With this configuration, the adjustment of the ink droplet ejection property by way of the individual nozzles are performable appropriately based on the prepared correction data.

Still more specifically, in the driving signal shown in FIG. 7, signals for three waveforms with a pulse width of T_{A0}, T_{B}, T_{C} are respectively used as signals respectively for the waveforms A, B, and C with respect to the normal nozzles. A saw tooth wave indicated as a waveform “a” (pulse width T_{A}) in the diagram is used as a signal for the waveform A that is the voltage change signal. As used herein, the term “a saw tooth wave” denotes a signal whose voltage changes in a saw tooth shape.

In this case, the voltage change signal is conceivable as a signal whose voltage changes depending on an applied pulse width. Therefore, an effective voltage that the piezo element receives according to a voltage change signal changes according to timing at which the piezo element receives the signal of the waveform A that is the voltage change signal.

When the time period during which the signal of the waveform A is supplied to the piezo element is set to a time period of T_{A0} in the diagram, a maximum voltage (absolute value) received by the piezo element is V_{pushA0}. When changed to T_{A1} by decreasing the time period during which the signal of the waveform A is supplied to the piezo element, a maximum voltage received by the piezo element is lowered from V_{pushA0} to V_{pushA1}. Accordingly, an amount of displacement of the piezo element according to the first pull signal also changes.

With this configuration, the effective voltage of the first pull signal is changeable in such a manner that the saw tooth shaped waveform (a₀) that changes with time is applied, in common, to all of the nozzles, and a pulse width supplied to the individual piezo elements are individually set on a per-nozzle basis by the timing setter 22. Thereby, the voltage of the driving signal is effectively changeable with a simpler configuration, instead of directly changing the voltage of the driving signal.

Therefore, with this embodiment, the effective voltage of the driving signal supplied to the piezo elements respectively corresponding to the individual nozzles is individually and appropriately adjustable. As described above, the variation in volume ejected from the nozzles of the inkjet head is usually approximately 20% or less. In such a case, the variation in volume of ink droplets is correctable appropriately by the method described above. Hence, with this embodiment, the variation in ejection volume of the individual nozzles is correctable appropriately with a simple method that does not make a circuit scale too complicated.

More specifically, this embodiment is capable of considerably reducing the scale of the necessary circuit configuration than the case of disposing the voltage regulator circuit for adjusting the voltage of the driving signal on a per-nozzle basis. Thus, the effective voltage of the driving signal is individually settable on a per-nozzle basis on the circuit scale in a practical range. With this embodiment, it is therefore possible to appropriately reduce the influence of the variation in ejection properties of the nozzles to a range in which no practical problem occurs.

As to the driving signal, the segment of the waveform A corresponding to the first pull signal is made in the saw-tooth shaped wave has been described above. However, when considered in a more generalized manner, besides the segment of the waveform A, another segment (the segment of the waveform B or C) may be a signal whose voltage value changes with time, such as the saw-tooth shaped wave. In other words, the voltage change signal may be at least one of the first pull signal, the push signal, and the second pull signal.

Also in this case, effective voltages that the individual piezo elements receive based on the voltage change signal are individually settable on a per-nozzle basis by regarding, as the voltage change signal, a portion for which the saw-tooth wave or the like is used, and individually setting, on a per-piezo element basis, a time period (such as a pulse width) during which the individual piezo elements receive the voltage change signal. Thereby, the amount of displacement of each of the piezo elements is individually changeable, thus making it possible to individually control the ejection amount of ink droplets from the corresponding nozzle.

Also in this case, with respect to a plurality of nozzles that differ from each other in volume of ink droplets ejected upon receipt of an identical driving signal, an adjustment is carried out so that their respective volumes of ink droplets come closer to each other by causing the piezo elements to receive the voltage change signal in different time periods. This configuration makes it possible to appropriately carry out the adjustment of the ejection property of liquid droplets by way of the individual nozzles.

When the voltage change signal is considered in a more generalized manner, the voltage change signal can also be said to be a signal repeated in a preset cycle, and a signal whose voltage gradually changes in one direction according to the passage of time in the cycle. As used herein the term “signal whose voltage gradually changes in one direction according to the passage of time in the cycle” denotes a signal whose voltage gradually increases in the cycle, or a signal whose voltage gradually decreases in the cycle. In this case, the voltage may be changed stepwise at a boundary part of the cycle. This configuration leads to a more appropriate change of the voltage of the voltage change signal. On this occasion, by assigning a voltage in any one of time periods in the cycle to each of the piezo elements on a per-piezo element basis, it is possible to appropriately adjust the effective voltage that each of the piezo elements receives based on the voltage change signal. This leads to a more appropriate adjustment of the ejection property of liquid droplets by way of the individual nozzles.

As to the timing at which the voltage change signal is supplied to the individual piezo elements, the timing setter 22 may be capable of setting a plurality of preset kinds of time periods as a time period in which the piezo elements receive the voltage change signal. On this occasion, the timing setter 22 sets a time period in which each of the piezo elements receives the voltage change signal by selecting one of the plurality of kinds of time periods.

In association with the ejection property correction carried out in this embodiment, a relationship with a hitting position of ink droplets is described below. As describer earlier, with this embodiment, the volumes of droplets ejected from the individual nozzles are individually and appropriately adjustable on a per-nozzle basis. As to the variation in ejection properties of the nozzles, however, it is desirable to also consider the variation in hitting position of ink droplets besides the volume of ink droplets. In this regard, the variation in the hitting position of ink droplets is not irrelevant to the variation in volume of ink droplets, but there is usually a correlation between the two.

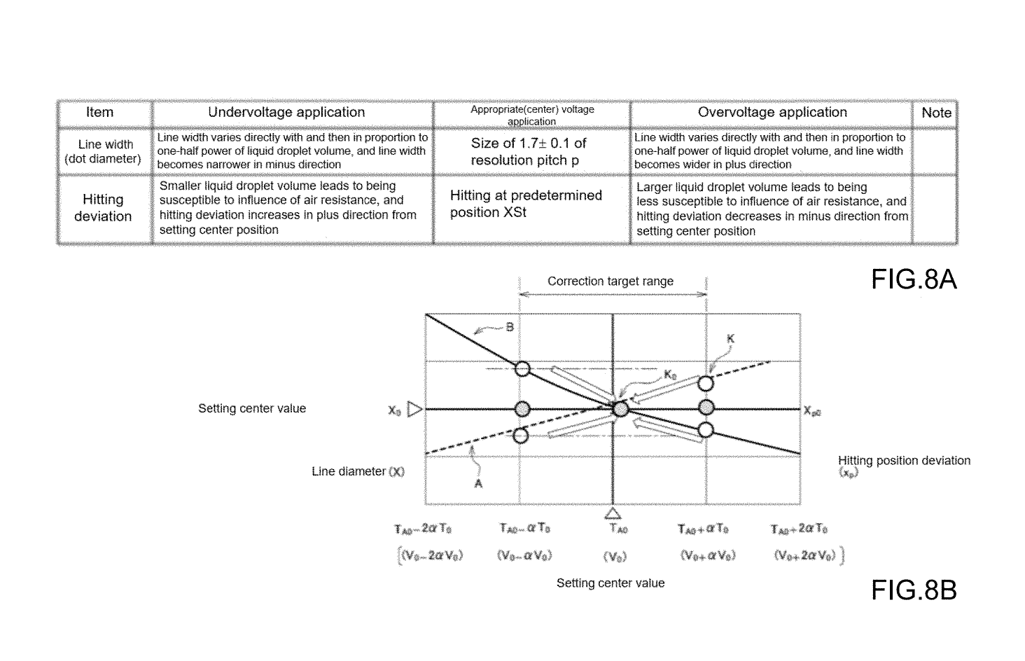

FIG. 8 is a diagram that describes a relationship between the volume of ink droplets and the hitting position. FIG. 8(a) is a table that shows an example of a relationship between a line width of a straight line determined depending on the volume of ink droplets, and a hitting position deviation (hitting deviation), namely, a relationship between a voltage of the driving signal, a line width (line diameter), and a hitting deviation when ink droplets are ejected from the nozzle with the normal ejection property.

As shown in the diagram, when the voltage of the driving signal supplied to the piezo element corresponding to the normal nozzle is appropriate, a diameter of a dot of ink formed has a size within a predetermined range according to a resolution pitch. Accordingly, when a straight line is drawn by the normal nozzle, the straight line having a line width within a predetermined normal range is drawable. A hitting position corresponds to a predetermined position (set center position) being set according to a resolution.

Meanwhile, when a voltage of the driving signal is changed, the diameter of the dot of ink and the hitting position change according to the voltage of the driving signal In the case where the voltage of the driving signal is lowered so as to apply an undervoltage, the volume of ink droplets (liquid droplet volume) decreases, and a line width drawn becomes narrow. The hitting position is susceptible to the influence of air resistance due to a decrease in the liquid droplet volume, so that the hitting position is increased in the plus direction from the center setting position. In contrast, in the case where the voltage of the driving signal is increased so as to apply an overvoltage, the volume of ink droplets increases, and a line width drawn becomes wide. The hitting position is less susceptible to the influence of air resistance due to an increase in the liquid droplet volume, so that the hitting position is decreased in the minus direction from the center setting position.

FIG. 8(b) is a diagram that shows a relationship between a line width (line diameter) and a hitting deviation when ink droplets are ejected from a nozzle with normal ejection property, and shows a line diameter X that is a thickness of a straight line drawn, and a deviation Xₚ in hitting position when a pulse width T that changes the effective voltage of the waveform A in the driving signal is changed variously. In this diagram, a straight line identified by alphabetic character A shows a relationship between a line diameter X and a pulse width T. A straight line identified by alphabetic character B shows a relationship between a deviation Xₚ in hitting position and a pulse width T.

As apparent from this diagram, the line diameter X and the deviation Xₚ in hitting position do not change independently, but change while retaining correlation with the change of the effective voltage of the driving signal. Therefore, the line diameter X and the deviation Xₚ in hitting position can be changed at the same time by changing the effective voltage of the driving signal. More specifically, as seen in FIG. 8, the deviation in hitting position moves in a direction to return to the center value width T simultaneously with making a correction for returning the volume (line width) of ink droplets to the center value X₀. On this occasion, the ejection property of the nozzle with poor ejection property is corrected by changing the pulse width T so as to change the effective voltage of the driving signal. This ensures that the line diameter (volume of ink droplets) and the hitting position are correctable (improvable) at the same time.

As to the ejection property correction carried out in this embodiment, the foregoing has described mainly the method of correcting the volume of ink droplets by adjusting the line width of a straight line drawn into the fixed range. When correcting the volume of ink droplets, however, it is also possible to simultaneously correct the deviation in hitting position as described above. Hence, in the correction for the ejection property, the correction may be carried out taking into consideration both of the line width of a straight line drawn and the deviation in hitting position. In this case, it is conceivable to control so that a sum of a deviation in line width and a deviation in hitting position, and an average value of the two are minimized.

In this embodiment, a correctable range for the effective voltage of the driving signal by employing a pulse width driving effective voltage control mode is approximately ±25% (α=0.25) with respect to the center voltage V₀. Accordingly, the line width of a straight line drawn is correctable appropriately in a range of approximately ±25% with respect to a predetermined center value. With this embodiment, during manufacturing of the inkjet heads, the number of the inkjet heads whose ejection property becomes normal by the correction can be increased appropriately, so that the inkjet heads can be manufactured more appropriately at high yield.

More specifically, when using the driving signal shown in FIG. 7, variations, such as the volume of ink droplets, are correctable in the following procedure. In this case, a line width of a straight line drawn upon application of a fixed pulse width T_{A0} corresponding to a set center value (a print line width on a per-nozzle basis) is measured on all of the nozzles. Then, a deviation from the set center value of the line width (deviation of the volume of ink droplets) is calculated based on the measured print line width on a per-nozzle basis. An applied pulse width T_{An}, by which the line width can be returned to the set center value X₀, is found based on the deviation of the line width in each of the nozzles. When a position subjected to the deviation of the line width lies at a position identified by alphabetic character “k” in FIG. 8, it is conceivable that it returns to a point k₀ of the center value X₀, by decreasing the pulse width by αT₀, and the line diameter, namely, the volume (size) of ink ejected is returnable to the set center value.

Subsequently, based on the deviation from the center value of the line width found on a per-nozzle basis, the applied pulse width T_{An} for returning to the set center value is applied to each of the nozzles. The line width variation is then remeasured. The correction is completed when the line width variation is a fixed value or less in the remeasurement. In the presence of a nozzle whose deviation of the line width is beyond a predetermined range, a correction similar to the above is carried out again on the nozzle. A pulse velocity Vᵢ after correction is applied to the nozzle, and the line width is remeasured. The correction is completed when the line width variation is a fixed value or less.

When the correction is not completed even when repeating the above correction a predetermined number of times, it is preferable to perform a recovery operation, such as cleaning of the inkjet head. When the correction is not completed even when the above correction is carried out after the recovery operation, a determination may be made that the inkjet head is defective, and the correction operation may be terminated.

A change in the deviation of a hitting position of ink droplets is supplementarily described below. As described earlier, when ink droplets are ejected by inkjet technology, the influence of air resistance exerted on the ink droplets changes depending on the volume of the ink droplets. Consequently, the deviation of the hitting position also changes depending on the volume of the ink droplets.

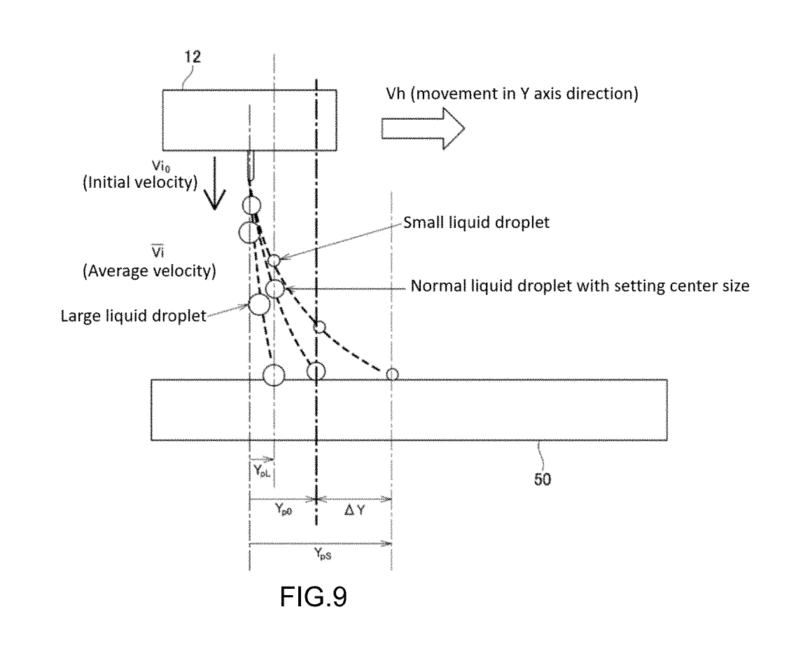

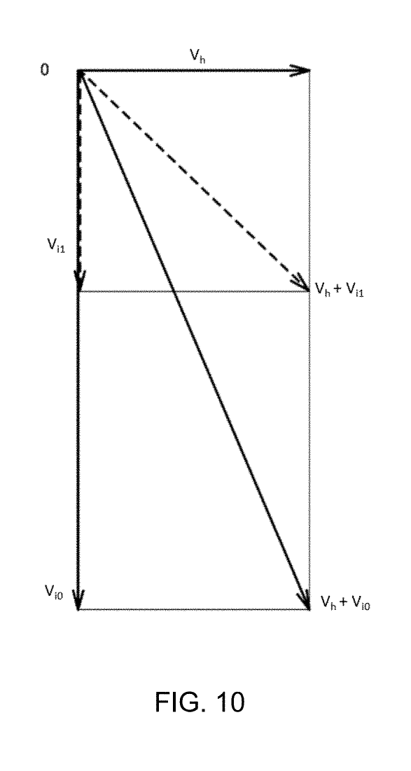

FIGS. 9 and 10 are diagrams that respectively describe a change in deviation of a hitting position of ink droplets. FIG. 9 is a diagram that shows an example of a situation where a hitting position changes due to a change in the volume of ink droplets, by way of modeling a deviation situation of the hitting position during a wide gap with an increased distance (print gap) between the inkjet head and a medium. FIG. 10 is a diagram that shows an example of velocity components of ink droplets in the middle of flight.

A change in the volume of ink droplets results in a change in the hitting position of the ink droplets as shown in FIG. 9. This is because a change in the volume of ink droplets results in a change in kinetic energy and a change in air resistance of the ink droplets, thereby resulting in a change in average velocity Vᵢ of the ink droplets. As used herein, the term “average velocity Vᵢ of the ink droplets” denotes an average velocity of the ink droplets passing through the print gap. On this occasion, the velocity drops greatly because the influence of the air resistance increases with decreasing volume of liquid droplets.

More specifically, when the average velocity Vᵢ changes from Vᵢ₀ to Vᵢ₁ as shown in FIG. 10, a direction of a composite velocity (Vₕ+Vᵢ) with a movement velocity Vₕ in the main scanning direction (Y direction) in the inkjet head during the main scanning operation changes from (Vₕ+V₀) to (Vₕ+Vᵢ₁). This causes a change in flying direction of the ink droplets, resulting in a change in hitting position. When a flying velocity of ink droplets decreases, a flying curve enlarges, thus leading to a large deviation in hitting position.

An amount of change in hitting position is sufficiently minimized when the velocity Vᵢ of ink droplets is sufficiently larger than Vₕ (when Vᵢ>>Vₕ). However, when the velocity Vᵢ of ink droplets lowers from a state of Vᵢ>>Vₕ and approaches a condition of Vᵢ≠Vₕ, the deviation in hitting position becomes more remarkable. Therefore, the influence of the variation in ejection properties of the nozzles may be emphasized and appear more remarkably under the condition that the print gasp is large, and under the condition that the moving velocity of the inkjet head during the main scanning operation is large.

Meanwhile in this embodiment, the line width of a straight line drawn is appropriately adjustable according to the use conditions (printing conditions) of the liquid ejection apparatus by changing the pulse width for controlling the timing of supplying the driving signal so as to change the effective voltage of the driving signal. This makes it possible to simultaneously appropriately correct the variation in volume of ink droplets and the variation in hitting position. With this embodiment, it is therefore possible to more appropriately perform printing with high accuracy even when the printing is carried out under a variety of conditions.

The correction operation carried out in this embodiment is described in more detail below. As described earlier, in this embodiment, the ejection property of each of the nozzles 102 is obtained by measuring a line width of a straight line drawn by each of the nozzles 102 (refer to FIG. 1) in the inkjet head 12. In the process of obtaining the ejection property of the nozzles 102, more specifically, a deviation from the center value in an ejection amount of ink droplets is calculated for each of the nozzles 102, and the amount of deviation in the plus or minus direction is divided into a plurality of n-stages.

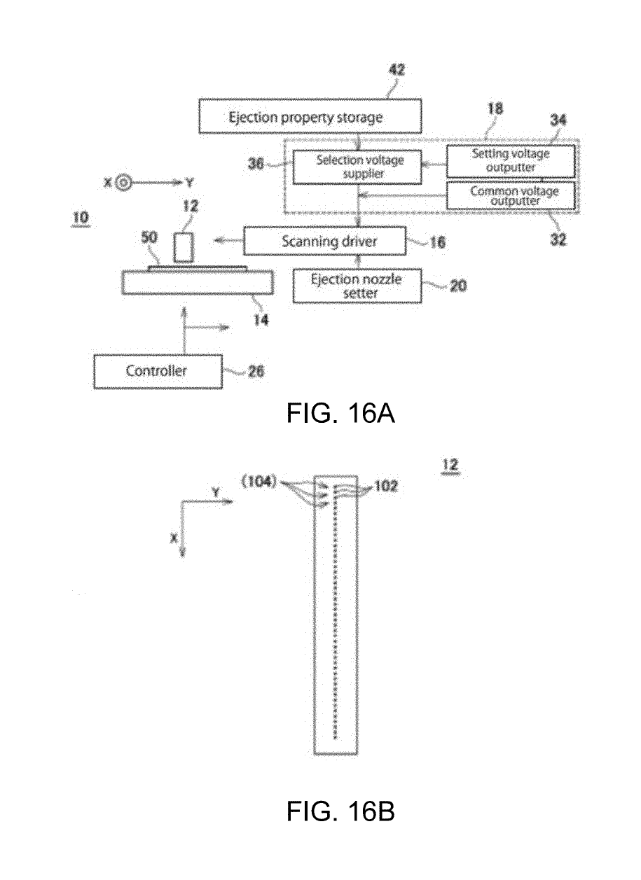

In the process of correcting the ejection property, the setting voltage outputter 34 (refer to FIG. 16 described later) outputs, as a signal constituting a part of the driving signal, a plurality of setting voltage signals that differ from each other in voltage. Then, a selection voltage supplier 36 (refer to FIG. 16) that is a power supply selection circuit capable of selecting a plurality of n-stages of applied voltages selects one of the setting voltage signals according to the measured ejection property with respect to the piezo element 104 respectively corresponding to the nozzles 102. The selection voltage supplier 36 also supplies, as a part of the driving signal, the selected setting voltage signal to the piezo element 104. More specifically, in this embodiment, the selection voltage supplier 36 selects a setting voltage signal for returning the ejection amount of the ink droplets to the center value direction. Thus, the selection voltage supplier 36 selects the applied voltage to the piezo element 104 according to the amount of variation in ejection amount for each of the nozzles 102.

A more specific circuit configuration that drives the piezo elements in this embodiment, and a modification of the driving signal, or the like are described below. An embodiment of the more specific circuit configuration that drives the piezo elements in this embodiment is described first.

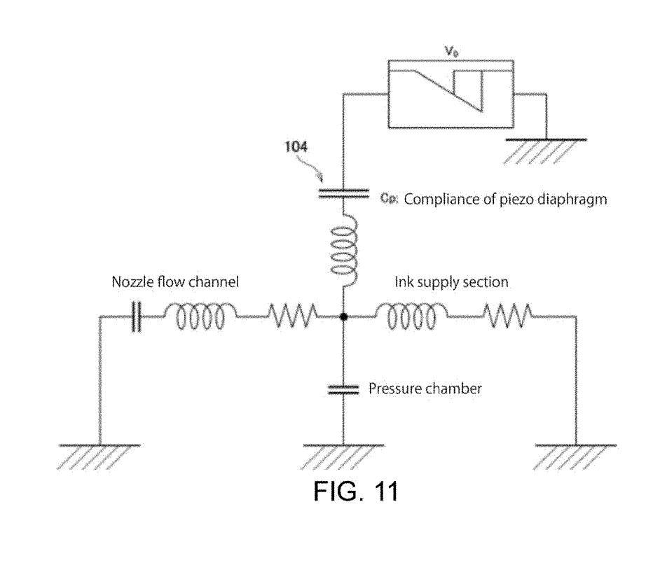

FIG. 11 is a diagram that shows, in a simplified form, an equivalent circuit of a driving circuit to drive the piezo element 104 in the inkjet head. As the driving circuit to drive the piezo element 104 in the piezo inkjet head, the equivalent circuit in which the piezo element 104 is replaced with a capacitor is conceivable as in the configuration shown in FIG. 11. In this embodiment, a voltage of the driving signal including the waveform A of the saw-tooth shaped wave with a pulse width T_{A} as shown in FIG. 7 is applied to, for example, a common electrode of a plurality of the piezo elements 104.

On this occasion, energization time to supply the signal of the waveform A to each of the piezo elements 104 is set to a necessary optional value by a function of a timer in the timing setter 22 (refer to FIG. 1). In this case, it is conceivable to set to T_{A0} and T_{A1} shown in FIG. 7. A signal voltage of the waveform A is applied to each of the piezo elements 104 only during the set time (T_{A}). With this configuration, the peak voltage of the saw-tooth shaped wave is continuously changeable by changing the energization time.

After termination of the supply of the signal of the waveform A, the voltage of the waveform A falls by being shut off by a switching circuit, and the waveform B in the driving signal shown in FIG. 7 rises in synchronization with the falling. When the waveform B is terminated, the waveform C rises in synchronization with the termination, thereby completing one of the waveform shown in FIG. 7. This embodiment makes it possible to appropriately supply the driving signal including the voltage change signal to each of the piezo elements 104.

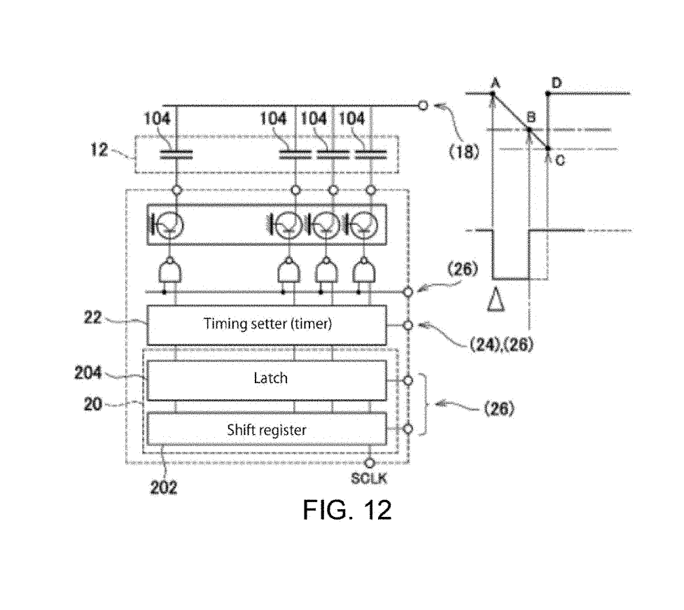

FIG. 12 is a diagram that shows more specifically a configuration for supplying the driving signal to the piezo element 104. In this embodiment, the driving signal outputter 18 supplies the driving signal to an electrode common to the piezo elements 104. The ejection nozzle setter 20 includes a latch 204 and a shift register 202. The ejection nozzle setter 20 selects the nozzle that needs to eject ink droplets, according to an instruction received from the controller 26. The timing setter 22 has a timer function of controlling timing of supplying the driving signal to each of the piezo elements 104. The timing setter 22 controls timing of supplying the driving signal to each of the piezo elements 104 according to an instruction from the controller 26, based on the correction data received from the correction data storage 24.

The ejection nozzle setter 20 and the timing setter 22 or the like may be coupled to the piezo element 104 through a circuit configuration similar to a well-known configuration to control the operation of the piezo elements 104. In the case shown, the ejection nozzle setter 20 and the timing setter 22 may be coupled to the piezo element 104 through different logic circuits and a transistor for switching. This embodiment makes it possible to appropriately supply the driving signal to each of the piezo elements 104.

The circuit configuration shown in FIG. 12 shows, as a reference, an embodiment of the circuit configuration used in this embodiment by making a simple change in the well-known circuit configuration. It is preferable to suitably make a further change in a more specific circuit configuration according to the property of a driving signal used, the property of the piezo elements 104, or the like. This configuration makes it possible to more appropriately supply the driving signal to the individual piezo elements 104.

A modification of the driving signal used in this embodiment is described below. The foregoing has described mainly the case of using the saw-tooth shaped wave as the voltage change signal included in the driving signal. Besides the saw-tooth shaped wave, other waveform signals may be used as the voltage change signal. On this occasion, it is preferable to use a signal whose voltage peak value changes by controlling a pulse width.

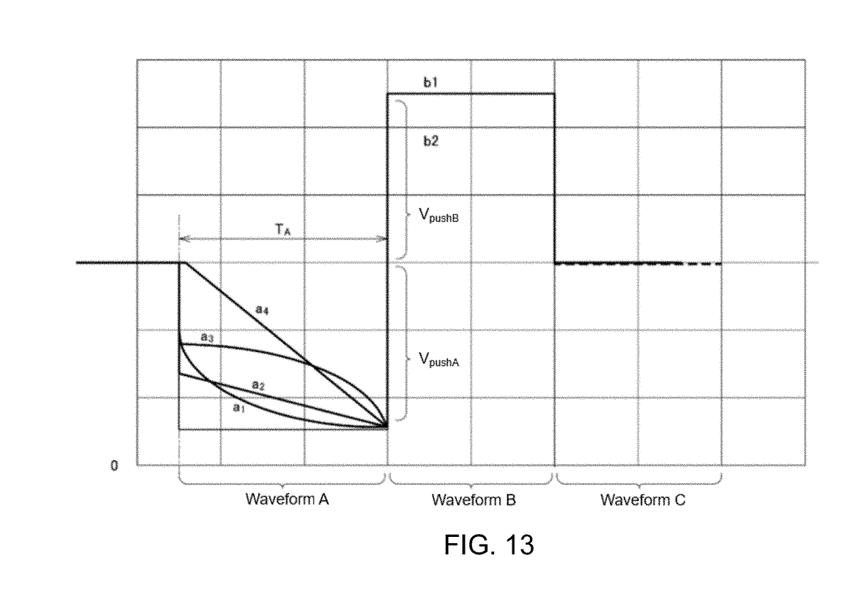

FIG. 13 is a diagram that shows a modification of the driving signal, specifically the case where various signals other than the saw-tooth shaped wave are used for the segment of the waveform A corresponding to the voltage change signal. As shown in the diagram, various signals, such as those identified by alphanumeric characters a₁ to a₄ in the diagram, are usable as the voltage change signal. Alternatively, a voltage change signal that changes similarly may be used for the segment of the waveform B or C.

It is also conceivable to use, as the driving signal, a signal that inverts polarity at predetermined timing by using an inverting converter circuit or the like. On this occasion, it is conceivable to change an effective voltage applied to the piezo element by inverting the polarity of the driving signal including the voltage change signal by the inverting converter circuit controlled using an input current. Also in this case, the pulse widths of the voltage change signals can individually be controlled to appropriately adjust the effective voltage by changing the inverting timing on a per-piezo element basis.

More specifically, on this occasion, the timing setter 22 (refer to FIG. 1) inverts the polarity of the voltage change signal in the middle of a cycle, and individually sets the timing of inverting the polarity on a per-driving element basis. This leads to individual settings for a time period during which each of the piezo elements receives the voltage change signal before and after polarity inversion. With this configuration, it is possible to more appropriately change the voltage of the voltage change signal.

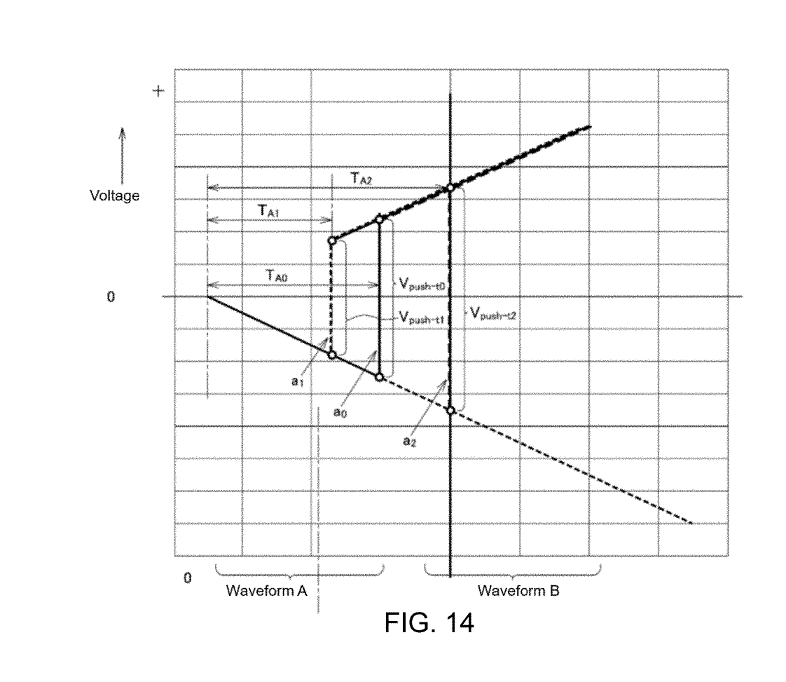

FIG. 14 is a diagram that shows another modification of the driving signal, specifically an embodiment of the driving signal when inverting the polarity at predetermined timing. In this case, the driving signal of a waveform shown in the diagram is obtainable by subjecting a saw-tooth wave inputted to polarity inversion using the inverting converter circuit after a predetermined time is passed. Assuming that T_{A0} (line a₀) is initial (referential) inverting timing for which no correction is made, the polarity is inverted at timing, such as T_{A1} (line a₁) or T_{A2} (line a₂), which is different from T_{A0}, thereby making it possible to slightly change Vₚᵤₛₕ₋ₜ₀, which is an initial push voltage, into Vₚᵤₛₕ₋ₜ₁, or alternatively significantly change it into Vₚᵤₛₕ₋ₜ₂. Also in this case, the effective voltage of the driving signal supplied to the piezo element can be changed appropriately.

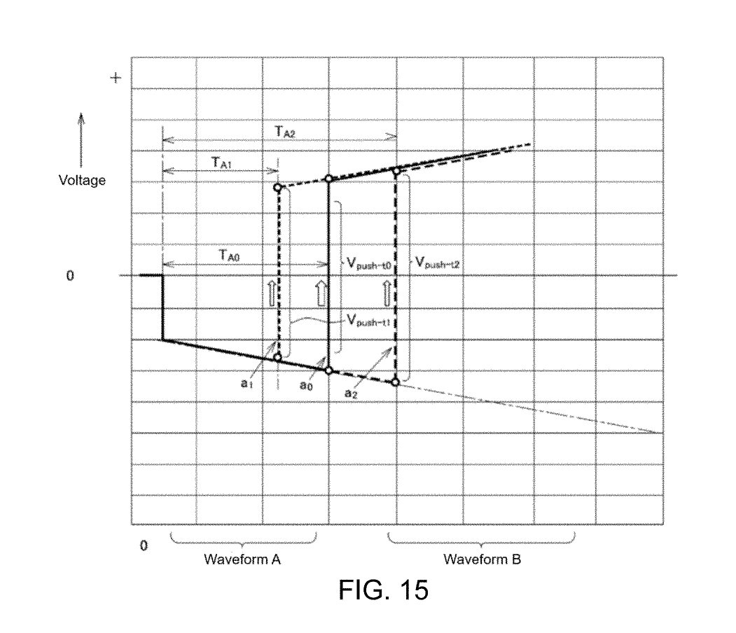

Also in this case, a signal of a waveform other than the saw-tooth shaped wave may be used as the voltage change signal. FIG. 15 is a diagram that shows still another modification of the driving signal, specifically an embodiment of the driving signal when inverting the polarity at predetermined timing by using the signal of a waveform other than the saw-tooth shaped wave. Also in this case, the effective voltage of the driving signal supplied to the piezo element can be changed appropriately as in the case described with reference to FIG. 14.

Furthermore, because the input voltage changes gently as compared with the case of inverting the input voltage of the saw-tooth shaped wave, it is possible to more finely change the voltage than the case of using the saw-tooth shaped wave. With this configuration, it is therefore possible to appropriately control a change in voltage with a smaller width in a fixed time range.

The foregoing has shown and described mainly the case where the voltage changes linearly in the signal inputted as the voltage change signal. Alternatively, the voltage of a signal input may be changed curvilinearly. No particular limitation is imposed on a circuit for inverting an input voltage, and various configurations capable of switching the voltage at predetermined timing are usable. A relationship between positive and negative voltages may be a relative relationship as long as the effective voltage applied to electrodes of the piezo elements is changed.

FIG. 16 is a diagram that shows an embodiment of a liquid ejection apparatus 10 according to an embodiment of the invention of the present application. FIG. 16(a) shows an embodiment of a configuration of a main part of the liquid ejection apparatus 10. FIG. 16(b) shows an embodiment of a configuration of an inkjet head 12 in the liquid ejection apparatus 10. Description of the configuration similar to that in FIG. 1 is omitted.

In this embodiment, the liquid ejection apparatus 10 includes an inkjet head 12, a platen 14, a scanning driver 16, a driving signal outputter 18, an ejection nozzle setter 20, an ejection property storage 42, and a controller 26. The inkjet head 12 is an embodiment of ejection heads that eject liquid droplets by the inkjet technology. A well-known inkjet head is suitably usable as the inkjet head 12.

In this embodiment, the driving signal outputter 18 also includes a common voltage outputter 32, a setting voltage outputter 34, and a selection voltage supplier 36. The common voltage outputter 32 and the setting voltage outputter 34 are signal outputters that output a preset voltage signal, and respectively output signals constituting a segment of the a driving signal. More specifically, of these, the common voltage outputter 32 outputs a preset voltage signal as a signal constituting a part of the driving signal. Alternatively, the common voltage outputter 32 may output a plurality of signals respectively constituting different segments of the driving signal. These signals may be fixed voltage signals being set to voltages being different from each other.

The setting voltage outputter 34 outputs a signal constituting another segment of the driving signal. As used herein, the term “another segment of the driving signal” denotes the segment of the driving signal which is different from the segment constituted by the signal outputted from the common voltage outputter 32. In this embodiment, the setting voltage outputter 34 outputs a plurality of setting voltage signals, as these signals, which are a plurality of kinds of signals being set to voltages different from each other. In this case, the setting voltage signals are respectively signals individually selected for each of the piezo elements 104 respectively corresponding to the nozzles 102, and respectively constitute a segment of the driving signal supplied to the individual piezo elements 104.

In this embodiment, the setting voltage outputter 34 outputs fixed voltage signals whose voltages differ from each other, which respectively serve as the plurality of setting voltage signals. More specifically, the setting voltage outputter 34 outputs, these setting voltage signals, preset n-kinds (n is an integer of 2 or more) of setting voltage signals.

The selection voltage supplier 36 is a signal supplier that selects and supplies any one of the setting voltage signals to the piezo elements 104 respectively corresponding to the nozzles 102. More specifically, the selection voltage supplier 36 is a power supply selection circuit having a function capable of selecting a plurality of n-stages of applied voltages. The selection voltage supplier 36 supplies, as the driving signal, any one of setting voltage signals to the piezo element 104 corresponding to the nozzle 102 that ejects ink droplets at least in a time period during which the driving signal is supplied to the piezo element. In this embodiment, the selection voltage supplier 36 selects the setting voltage signal based on the ejection property of the nozzle 102 being stored in the ejection property storage 42. On this occasion, the selection voltage supplier 36 supplies the setting voltage signal previously associated with the ejection property of the nozzles 102, to the piezo elements 104 respectively corresponding to the nozzles 102. The driving signal used in this embodiment, and operations in individual configurations in the driving signal outputter 18 are described in more detail later.

Alternatively, the ejection nozzle setter 20 transmits a signal indicating the selected piezo element 104 to the scanning driver 16. Thus, the scanning driver 16 supplies the driving signal received from the driving signal outputter 18, to the piezo element 104 being selected by the ejection nozzle setter 20.

The ejection property storage 42 is a storage to store the ejection properties of the individual nozzles 102. The ejection property storage 42 stores, at a plurality of stages, measurement results of the ejection properties of the nozzles 102 previously measured. More specifically, in this embodiment, the ejection property storage 42 stores the ejection properties of the nozzles 102 by classifying them into any one of n-classes respectively associated with the n-kinds of setting voltage signals.

With this configuration, the ejection properties of the individual nozzles 102 can be stored appropriately in the ejection property storage 42. On this occasion, according to the segments under which the ejection properties of the nozzles 102 are classified by the ejection property storage 42, the selection voltage supplier 36 supplies the setting voltage signals associated with the segments to the piezo elements 104 respectively corresponding to the nozzles 102. With this configuration, the setting voltage signals according to the ejection property of the nozzle 102 can be supplied appropriately to the each of the nozzles 102.

The controller 26 controls operations of individual elements of the liquid ejection apparatus 10. The controller 26 may be a CPU of the liquid ejection apparatus 10. With this embodiment, a printing operation to the medium 50 is appropriately performable.

The individual elements, such as the scanning driver 16, the driving signal outputter 18, the ejection nozzle setter 20, and the ejection property storage 42, in the liquid ejection apparatus 10 have been described above, each of which is the configuration disposed outside the inkjet head 12. Alternatively, all or some of these elements may be disposed inside the inkjet head 12.

In this embodiment, the volume of ink droplets or the like is corrected with a smaller practical circuit scale by using the driving signal different from the conventional one. In this case, as described earlier, the driving signals are different from each other for each of the nozzles 102 (refer to FIG. 16) according to the ejection property by using the plurality of kinds of setting voltage signals whose voltages are different from each other, as the signal constituting a segment of the driving signal, and selecting the setting voltage signals according to the ejection property of each of the nozzles 102. This achieves the correction for the ejection property (the volume of ink droplets, or the like) on the practical circuit scale.

More specifically, in this embodiment, the driving signal outputter 18 (refer to FIG. 16) outputs, as at least a part of the driving signal, a first pull signal, a push signal, and a second pull signal, as in the case of the well-known push-pull mode. The first pull signal is a voltage signal causing the piezo element 104 (refer to FIG. 16) to be displaced so as to pull ink into the ink in the preceding stage of the nozzle 102 (refer to FIG. 16). The first pull signal may be a signal corresponding to the segment of the waveform A in FIG. 2.

The push signal is a voltage signal causing the piezo element 104 to be displaced so as to push out the ink pulled in according to the first pull signal. The push signal may be a signal corresponding to the segment of the waveform B in FIG. 2. The second pull signal is a signal causing the piezo element 104 to be displaced so as to push back part of the ink pushed out of the nozzle 102 according to the push signal. The second pull signal may be a signal corresponding to the segment of the waveform C in FIG. 2. The individual piezo elements 104 cause ink droplets to be ejected from their respective corresponding nozzles 102 by sequentially receiving the first pull signal, the push signal, and the second pull signal.

On this occasion, the setting voltage outputter 34 (refer to FIG. 16) in the driving signal outputter 18 outputs a plurality of setting voltage signals as a signal constituting at least one of the first pull signal, the push signal, and the second pull signal. Then, based on the ejection property of each of the nozzles 102, the selection voltage supplier 36 (refer to FIG. 16) selects any one of the setting voltage signals as at least one of the first pull signal, the push signal, and the second pull signal. The selection voltage supplier 36 then supplies the selected setting voltage signal to the piezo elements 104 respectively corresponding to the nozzles 102.

With this configuration, the ink droplets can be ejected from the individual nozzles 102 by causing the individual piezo elements 104 to sequentially receive the first pull signal, the push signal, and the second pull signal in an identical or similar manner as in the ejection of ink droplets by the well-known push-pull mode. By supplying a fixed voltage signal as at least one of the first pull signal, the push signal, and the second pull signal, the setting voltage signal of a voltage suitable for the ejection property of each of the nozzles 102 is supplied to the piezo element 104 so as to appropriately adjust the ejection property of the individual nozzles 102. Therefore, with this embodiment, the ejection property of the individual nozzles 102 is appropriately correctable on a practical circuit scale.

A correction operation and the like carried out in this embodiment are described in more detail below. A measurement operation and the like carried out prior to a correction are described first.

As described earlier, in this embodiment, the selection voltage supplier 36 selects a setting voltage signal supplied to the piezo elements 104 respectively corresponding to the individual nozzles 102, based on the ejection properties of the individual nozzles 102 being stored in the ejection property storage 42 (refer to FIG. 16). Thereby, the selection voltage supplier 36 adjusts (corrects) the ejection property of each of the nozzles 102 by individually setting for each of the nozzles 102, a voltage supplied to the piezo elements 104 at part of timing of the driving signal.

In this embodiment, a measurement for obtaining the ejection property of each of the nozzles 102 in the inkjet head 12 is previously carried out in order to carried out the above adjustment. More specifically, nozzle property data indicating the ejection property of the nozzles 102 are previously obtained by previously measuring the ejection property of the nozzles 102 in the case of using a preset reference driving signal. Based on the obtained nozzle property data, the ejection properties of the individual nozzles 102 are classified and stored in any one of n-classes.

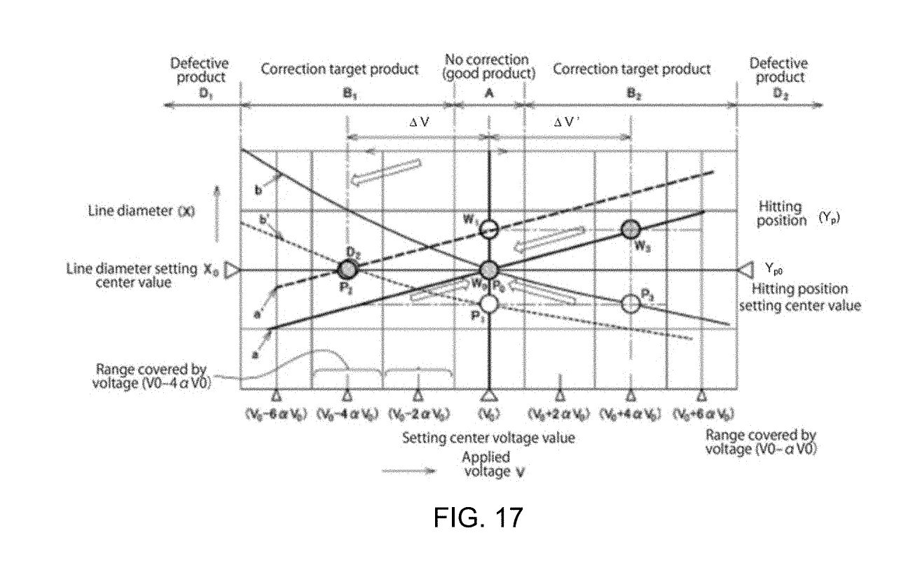

FIG. 17 is a diagram that describes in more detail a correction operation in the present embodiment, and shows a relationship between a line width (line diameter) of a straight line drawn by one nozzle, and a hitting deviation. Specifically, FIG. 17 shows, by way of example, a situation where a line diameter X that is a thickness of a straight line drawn, and a hitting position Yₚ change when variously changing an applied voltage V_{pullA} (=V_{pushA}) of the waveform A which causes displacement of the piezo elements 104. As used herein, the term “applied voltage V_{pullA} of the waveform A” is the applied voltage V_{pullA} of the waveform A in the driving signal shown in FIG. 2. In this diagram, lines respectively identified by alphabetic character “a” and a′ denote applied voltage V dependence of the line diameter X (line width X). The lines respectively identified by alphabetic character “b” and b′ denote applied voltage V dependence of the hitting position Yₚ.

A range A in FIG. 17 denotes a normal range requiring no correction. More specifically, when a permissible range of variation is α%, the nozzles in the range A are nozzles in which the deviation of the line diameter X is within ±α% of the center value X₀.

In this embodiment, a correction for the ejection property is made on the nozzles in the range identified as ranges B1 and B2. The nozzles in this range are nozzles whose abnormality of the line diameter X appears as image quality deterioration. In this embodiment, a range (range K) including the ranges A, B1, and B2 corresponds to the nozzles whose ejection property is adjustable to the normal range. Nozzles in ranges D1 and D2 lying further outside these ranges are nozzles beyond an ejection property correctable range. Therefore in this embodiment, a determination is made that the inkjet heads including the nozzles in the ranges D1 and D2 are defective inkjet heads.

More specifically, a curve (line “a”) identified by alphabetic character “a” is a line that indicates property of a nozzle having normal property corresponding to a center value, and shows results obtained by measuring changes in the line diameter X of a straight line (printed line width X) drawn by changing an applied voltage V that is a maximum value of a pulse voltage of the waveform A. The line diameter X changes in an upward slope with increasing voltage. This is because the volume of ink droplets ejected from the nozzle (an amount of ejected ink droplet increases in an upward slope in approximately proportional to voltage. In this embodiment, a relationship between an applied voltage and a line diameter in each of the nozzles is previously measured as in the case of the line “a” in FIG. 17, by changing a voltage corresponding to the applied voltage V of the waveform A in the driving signal shown in FIG. 2.

When the ejection property of the nozzle deviates from the normal property, a line indicating measurement result deviates from the line “a”. In a nozzle with poor ejection in which an ejection amount of ink becomes too large at the set center voltage V₀ and a line width becomes large as indicated by W₁ in the diagram, the measurement result is as indicated by the curve (line a′) identified by alphabetic character a′. That is, it is conceivable that dependence of the line diameter X on the applied voltage V in the nozzles results in the line a′ obtained by translating a form identical to that of the line “a” indicating voltage dependence of the nozzle with the normal ejection property.

In order to return the line width at a position of a point W₁ to X₀ at a point W₀ on the line a′, it can be seen in this case that the applied voltage needs to be decreased by ΔV as shown in the diagram. That is, the applied voltage needs to lowered from V₀ to (V₀−ΔV) in this case. A value of ΔV is approximately equal to a value with which a point W₃ is returned to Wo on the line “a”.

As described with reference to FIGS. 9 and 10, when ink droplets are ejected by the inkjet technology, a deviation of a hitting position changes depending on a volume in ink droplets. Consequently, the line diameter of the straight line drawn by each of the nozzles, and the deviation of the hitting position do not change independently, but change while retaining correlation. More specifically, as shown in FIG. 17, it can be seen in this case that when a correction is made for returning the volume of ink droplets (a print line width) to the center value X₀, the effect of the correction is also exerted on the variation in hitting position in a direction in which it is returned to the center value Yₚ₀. It can therefore be seen that the line diameter of the straight line Yⱼ line width, ejection amount) and the deviation of the hitting position in the Y axis direction can be improved together with use of one means by changing the applied voltage.

As described above, in this embodiment, the line width (line diameter) of the straight line drawn is corrected by changing the applied voltage V while being classified into a plurality of stages according to the variation in nozzle property, not in a continuous manner, at least any timing in the driving signal. On this occasion, the deviation of the hitting position is also correctable simultaneously with the line width. With this embodiment, it is therefore possible to correct the volume of the ink droplets and the hitting position deviation at the same time by using the applied voltage selected on a per-nozzle basis.

In order to appropriately improve yield of the inkjet head 12 for practical use, it seems necessary to set a correction range of variation in the line diameter of the print line width to a range of approximately ±25% with respect to the center value. In this regard, this embodiment is capable of easily and appropriately achieving the correction in this range by using a method of selectively switching the driving signal (driving voltage selective switching control method).

More specifically, this embodiment is capable of correcting the variation in volume of ink droplets or the like in the following procedure, based on the relationship between an applied voltage and a line diameter or the like shown in FIG. 17. That is, a measurement is made on all of the nozzles in terms of the line width of the straight line drawn (a printed line width on a per-nozzle basis) upon application of pulse of a fixed applied voltage V corresponding to the set center value. Based on the measured printed line width on a per-nozzle basis, a deviation from the set center value X₀ of the line width (a deviation of the volume of ink droplets) is calculated on a per-nozzle basis. Based on the calculated results, the ejection property of each of the nozzles is classified into any one of the preset stages according to a distance from the center value (a deviation). On this occasion, it is conceivable to classify into, for example, a segment A requiring no correction for the ejection amount as indicated as the range A in FIG. 17, and segments B1 and B2 of regions requiring the correction for the ejection amount of ink droplets. Specifically, the segment A is a segment of the nozzles in which the line width (line diameter) is in a range of X₀±αX₀ when α% is a permissible range of variation. The segment B1 is the segment of the nozzles whose line width is narrow. Therefore, a correction for increasing the line width is carried out for the nozzles of the segment B1. The segment B2 is a segment of the nozzles whose line width is wide. Therefore, a correction for decreasing the line width is carried out for the nozzles of the segment B2. Alternatively, the ranges of the segments B1 and B2 may be classified into finer segments. With this configuration, the correction with higher accuracy is performable.

In this embodiment, the nozzles whose volume of ink droplets exceeds a predetermined range are classified into segments D1 and D2 indicating the nozzles requiring no correction. On this occasion, a determination is made that the inkjet head having the nozzles classified into the segment D1 or D2 is a defective product.

As described earlier, in this embodiment, the setting voltage outputter 34 (refer to FIG. 16) outputs a plurality of setting voltage signals that differ from each other in voltage (voltage value) in order to correct the ejection property of the nozzles. The selection voltage supplier 36 (refer to FIG. 16) selects a setting voltage signal according to the ejection property of each of the nozzles, and supplies the setting voltage signal to the piezo element.

In this case, signals of the set center voltage V₀ and voltages changed at approximately equal intervals on both sides of positive and negative sides of the voltage V₀ are preferably used as the plurality of setting voltage signals. It is conceivable to output the plurality of setting voltage signals by, for example, a method of dividing a predetermined power supply voltage, or a method of using individual power circuits. In the selection voltage supplier 36, a circuit or the like having a function of selecting and changing the power voltage on a per-nozzle basis selects a setting voltage signal supplied to the piezo elements respectively corresponding to the nozzles.

On this occasion, an applied voltage capable of returning a line width deviation in each of the nozzles to a value closest to the set center value X₀ is found to connect a setting voltage signal whose voltage is closest. More specifically, the selection voltage supplier 36 couples the piezo element corresponding to the nozzle to a power supply corresponding to the setting voltage signal whose voltage is closest. Thus, the voltage for returning to the set center value is applied to the piezo elements respectively corresponding to the nozzles, according to a deviation from the center value of the line width found on a per-nozzle basis.

In this embodiment, the line width deviation is remeasured during adjustment of the ejection property in a state in which the setting voltage signal selected on a per-nozzle basis is used. The correction is completed when the line width variation is a fixed value or less in the remeasurement. In the presence of a nozzle whose deviation of the line width is beyond a predetermined range, a correction similar to the above is carried out again on the nozzle. The line width is remeasured in a state after being corrected again, and the correction is completed when the line width variation is a fixed value or less. In the case where the correction is completed when the line width variation is a fixed value or less, information indicating the setting voltage signals selected on a per-nozzle basis (selected power supply information) is stored in a circuit or the like so as to be automatically selectable during a printing operation.

When the correction is not completed even when repeating the above correction a predetermined number of times, it is preferable to perform a recovery operation, such as cleaning of the inkjet head. When the correction is not completed even when the above correction is carried out after the recovery operation, a determination may be made that the inkjet head is defective, and the correction operation may be terminated.

As to the ejection property correction carried out in this embodiment, the foregoing has described mainly the method of correcting the volume of ink droplets by adjusting the line width of a straight line drawn to the fixed range. When correcting the volume of ink droplets, however, it is also possible to simultaneously correct the deviation in hitting position as described above. Hence, in the correction for the ejection property, the correction may be carried out taking into consideration both of the line width of a straight line drawn and the deviation in hitting position. In this case, it is conceivable to control so that a sum of a deviation in line width and a deviation in hitting position, and an average value of the two are minimized.

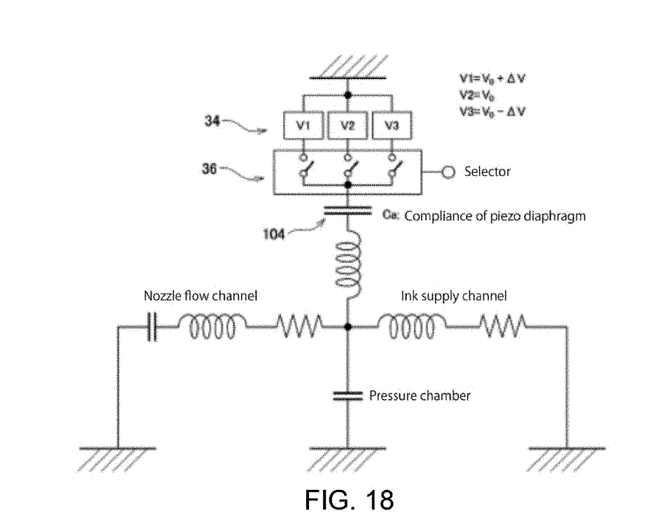

A more specific circuit configuration that drives the piezo elements in this embodiment is described in more detail below. FIG. 18 is a diagram that shows, in a simplified form, an equivalent circuit of a driving circuit (head driving circuit) to drive the piezo element 104 in the inkjet head (an equivalent circuit model of a driving voltage selection switching method), and shows, in a simplified form, an equivalent circuit related to the setting voltage outputter 34 and the selection voltage supplier 36. In this embodiment, the head driving circuit further includes the common voltage outputter 32 or the like as described with reference to FIG. 16. For the sake of illustration, the common voltage outputter 32 and the like are omitted in FIG. 18.

In the piezo inkjet head, it is conceivable to employ, as the driving circuit to drive the piezo elements 104, the equivalent circuit in which the piezo element 104 is replaced with a capacitor as in the configuration shown in FIG. 18. In the configuration shown in the simplified form in FIG. 18, the setting voltage outputter 34 outputs setting voltage signals of three kinds of voltages of V₁=V₀+ΔV, V₂=V₀, and V₃=V₀−ΔV. In the selection voltage supplier 36, a selector performs switching between three stages of V₁, V₂, and V₃. These switching stages, a variation width of a voltage switched, or the like are those which are changed according to a degree of the variation in ejection properties of the nozzles in the inkjet head, and a required image quality level. It is therefore not intended to limit to a specific number.

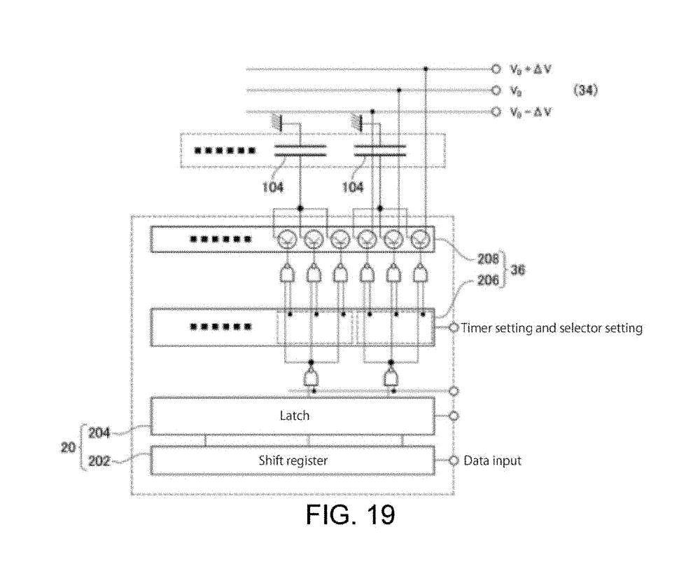

FIG. 19 is a diagram that shows more specifically a part of the driving circuit to supply a driving signal to the piezo element 104. In a configuration shown in the diagram, the driving signal outputter 18 outputs a plurality of setting voltage signals that differ from each other in voltage to an electrode common to the piezo elements 104. The ejection nozzle setter 20 includes a shift register 202 and a latch 204, and selects a nozzle that needs to eject ink droplets according to an instruction received from the controller 26 (refer to FIG. 16). The selection voltage supplier 36 includes a selector 206 and a switching circuit 208, and selects a setting voltage signal that needs to be supplied to the piezo elements 104 respectively corresponding to the nozzles, based on an instruction received from the controller 26, and ejection properties of the nozzles being stored in the ejection property storage 42 (refer to FIG. 16). Alternatively, the selection voltage supplier 36 may receive data indicating a predetermined power supply used for a nozzle variation correction, as the ejection property of each of the nozzles being stored in the ejection property storage 42. As used herein, the term “data indicating a predetermined power supply used for a nozzle variation correction” is more specifically data indicating a setting voltage signal that needs to be used for correcting the ejection property of the nozzle. Thus, the selection voltage supplier 36 determines voltages (setting voltage signals) connected on a per-nozzle basis. The selection voltage supplier 36 also sets an on-time of output by using a timer function.

In other respects, the configurations of the individual elements may have an identical or similar characteristic feature to the well-known configuration to control the operation of the piezo elements 104. The configurations of the individual configurations may be coupled to each other through different logic circuits and a transistor for switching as in the case shown. This embodiment makes it possible to appropriately supply the driving signal to each of the piezo elements 104. By switching the setting voltage signal supplied to each of the piezo elements 104 by, for example, the switching circuit 208 in the selection voltage supplier 36, the setting voltage signal corresponding to the power supply of the voltage capable of reducing the variation in printed line width can be appropriately selected and supplied to the piezo elements 104, based on the ejection properties of the nozzles obtained by, for example, previously measuring the printed line width. Thus, the variations of the volume of ink droplets or the like are appropriately correctable by a combination of an actually measured line width and the driving voltage selection switching control method.

The circuit configuration shown in FIG. 19 shows, as a reference, an embodiment of the circuit configuration used in this embodiment by making a simple change in the well-known circuit configuration. It is preferable to suitably make a further change in a more specific circuit configuration according to the property of a driving signal used, the property of the piezo elements 104, or the like. This configuration makes it possible to more appropriately supply the driving signal to the individual piezo elements 104.

A modification of the driving signals used in this embodiment is described below. The foregoing has described mainly the case of variously changing the applied voltage of the waveform A in the driving signals described with reference to FIG. 2. However, an object whose voltage is changed by using a plurality of setting voltage signals is not limited to the segment of the waveform A, and the object may be another segment. When causing the nozzles to eject ink droplets by the push-pull mode, besides the voltage for the “pull 1 mode” corresponding to the waveform A, one of voltages for the “push mode” and pull 2 mode” respectively corresponding to the waveforms B and C may be changed variously. In other words, when using the driving signal identical or similar to the driving signal described with reference to FIG. 2, a voltage value of at least one of the waveforms A, B, and C may be switched into a plurality of stages according to the ejection property (ejection state) of the nozzle. When considered in a more generalized manner, a configuration capable of switching voltages supplied on a per-piezo element basis may be applied to at least a partial waveform of the driving signal.

It is also conceivable to further modify the driving signal used. It is still conceivable to use, as the driving signal, a signal for inverting polarity at a predetermined timing by using an inverting circuit or the like.

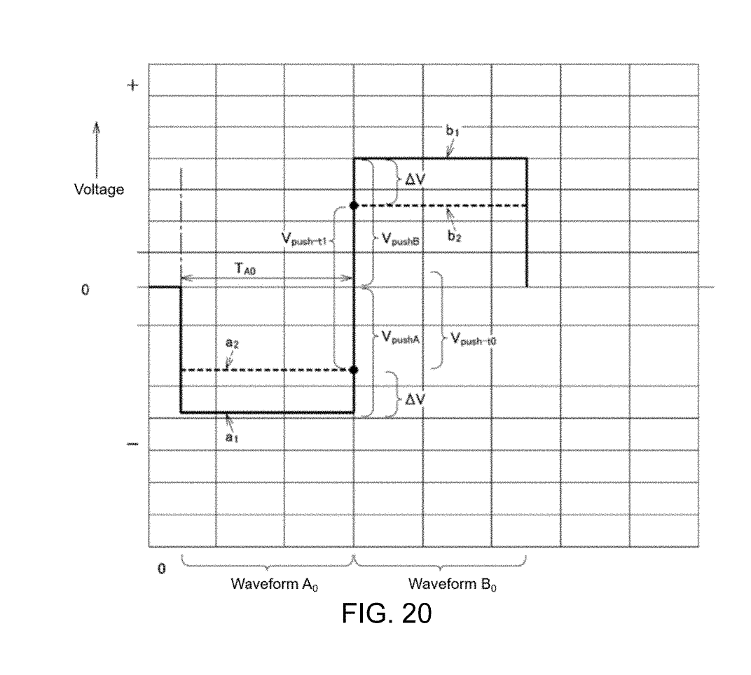

FIG. 20 is a diagram that shows a modification of the driving signal, namely, an example of the driving signal when using the signal for inverting the polarity at the predetermined timing. In this case, a waveform B₀ after the predetermined timing is a waveform obtained by inverting an earlier waveform A₀. This configuration leads to that positive and negative applied voltages change at the same time as shown in the diagram. Consequently, when a waveform a₁ is changed to a₂ in the segment of a waveform A₀, a total pull voltage Vₚᵤₛₕ−t₀ is 2Δ that is two times a variation ΔV from the waveform a₁ to a₂ in the segment of the waveform A₀. Even when using this driving signal, the applied voltages to the piezo elements respectively corresponding to the nozzles are changeable appropriately according to the ejection property of the nozzles. This leads to an appropriate correction for the ejection properties of the nozzles.

The following is a further supplementary description of the characteristic features and effects of the present embodiment. As described earlier with reference to FIG. 6 and the like, almost all of the defective nozzles in the inkjet heads often occur due to the variation of ±20% wt % or less in terms of ejection amount of ink. The inventor of the present application has focused on this point and conceived a method of adjusting the ejection property of the nozzles with a practical-scale circuit configuration.

As this method, the inventor has conceived more specifically a method of switching a voltage according to the ejection property about at least a partial waveform of the driving signal supplied to the piezo elements respectively corresponding to the nozzles (a driving method of driving voltage selection switching control mode) by previously obtaining the ejection properties of the nozzles with the method described with reference to FIG. 4 and the like. On this occasion, as the ejection property of each of the nozzles, a line width of a straight line drawn by each of the nozzles (a print line width) is measured by using a medium for evaluation 50 and ink used during an actual printing. In this measurement, a relationship between a voltage (a driving voltage) in a driving signal obtained by a combination of switchable voltages, and a change in line width needs to be previously found. A voltage of a driving signal supplied to the piezo elements respectively corresponding to the nozzles is determined based on these. In order to achieve this method, more specifically, a setting voltage signal supplied to each of the piezo elements is selected according to the ejection property of each of the nozzles, by using a plurality of setting voltage signals that differ from each other in voltage.

With this configuration, by individually setting the setting voltage signals respectively supplied to the piezo elements on a per-piezo element basis, voltages respectively applied to the piezo elements can be set individually on a per-piezo element basis at least at partial timing of the driving signal. This makes it possible to individually adjust, on a per-nozzle basis, the volume of ink droplets ejected from the individual nozzles according to the driving signal. With this configuration, the variation in the ejection property itself of the nozzle can be appropriately reduced without averaging the variations in ejection properties in the multi-pass mode or the like. Thus, the influence of the variation in ejection property which may occur on printing results is appropriately reducible to a level at which no practical problem occurs.

In this case, printing with high quality is appropriately performable by suppressing the variation in volume of ink droplets without the need for the printing in the multi-pass mode. Even when printing is carried out in the multi-pass mode, a necessary number of passes can be decreased appropriately. Hence, this embodiment also makes it possible to increase printing velocity. More specifically, the printing velocity is considerably increased (approximately 4 to 32 times) in this case by carrying out 1-pass printing instead of printing in the multi-pass mode.

Also in this case, the size of dots of ink formed on a medium is stabilized by suppressing the variation in volume of ink droplets or the like. Moreover, the width of dots in the sub-scanning direction is also stabilized, so that a region where the dots of ink are formed in the sub-scanning direction also becomes uniform. Consequently, the occurrence of stripe unevenness or the like is appropriately reducible to achieve printing quality with high image quality. As described above, the variation in hitting position in the main scanning direction is also appropriately reducible when the volume of ink droplets is stabilized. With this configuration, it is therefore possible to appropriately enhance the accuracy in the main scanning direction. This also leads to printing quality with the high image quality.

On this occasion, instead of finely adjusting a voltage itself supplied to the piezo elements respectively corresponding to the individual nozzles by a voltage regulator circuit or the like, a plurality of power supply voltages (“n” kinds of power supply voltages) are used to previously prepare a plurality of setting voltage signals, and a setting voltage signal used is selected according to the ejection property of the nozzle. This achieves a configuration capable of obtaining effects similar to those obtainable by adjusting the effective voltage on a per-nozzle basis, thereby correcting the ejection properties of the nozzles. Therefore, as compared with the case where a voltage regulator circuit for adjusting the voltage of the driving signal is disposed for each nozzle, the necessary circuit configuration scale is considerably reducible. Thus, the ejection properties of the nozzles are individually adjustable on a per-nozzle basis with a circuit scale in a practical range. With this configuration, the influence of the variation in ejection properties of the nozzles can be more appropriately reduced to a range in which no practical problem occurs.

In the configuration described above, the adjustment is made so that the volumes of ink droplets are closer to each other by supplying the different setting voltage signals to the nozzles that differ from each other in ejection property, namely, nozzles that differ from each other in volume of ink droplets ejected upon receipt of an identical driving signal. With this configuration, the adjustment of the ejection properties of ink droplets by way of the individual nozzles is more appropriately performable.

In this configuration, the ejection nozzle setter 20 (refer to FIG. 16) is capable of selecting, as a nozzle that ejects ink droplets, a plurality of nozzles that eject a preset identical volume of ink droplets. The term “a plurality of nozzles that eject a preset identical volume of ink” droplets denote a plurality of nozzles that ejects an identical volume of ink droplets in terms of design volume of ink droplets. More specifically, in such a configuration that one nozzle ejects only one kind of volume of liquid droplets, the term “an identical volume of liquid droplets” denotes the one kind of volume of liquid droplets. In such a configuration that one nozzle ejects a volume of liquid droplet selected from a plurality of kinds of volumes (the variable dot configuration), as in such a configuration that permits setting of a plurality of stages of volumes, whose volume of liquid droplets differ from each other, as a volume of ink droplets, the term “an identical volume of liquid droplets” may be any one of these stages of volumes of liquid droplets.

On this occasion, the ejection nozzle setter 20 may select, as a nozzle that ejects ink droplets according to the driving signal, a plurality of nozzles that eject an identical volume of liquid droplets based on image data that indicates an image to be printed. The setting voltage outputter 34 (refer to FIG. 16) outputs, in common, a plurality of setting voltage signals to a plurality of nozzles that eject the identical volume of ink droplets. Based on the ejection properties of the nozzles being stored in the ejection property storage 42 (refer to FIG. 16), the selection voltage supplier 36 (refer to FIG. 16) supplies a setting voltage signal previously associated with the ejection property of the nozzle to the plurality of nozzles that eject the identical volume of ink droplets. With this configuration, the adjustment of the ejection property of the nozzles is more appropriately performable.

It is conceivable to make the correction for the volume of ink droplets and the like described above, for example, at shipment of the liquid ejection apparatus 10 (refer to FIG. 16) from a factory, and during manufacturing of the inkjet heads. Alternatively, a user may perform the correction when using the liquid ejection apparatus 10. In the configuration of the liquid ejection apparatus 10, a plurality of printing conditions (print modes) are settable, and it is conceivable to change the printing conditions and volume of ink droplets depending on the print mode. In this case, for example, a correction range and a correction value may be changed depending on the print mode. No particular limitation is imposed on ink for use in the liquid ejection apparatus 10, and a variety of well-known inks are usable. When considered in a more generalized manner, it is conceivable to use a variety of liquids ejectable from the nozzles by the piezo elements or the like.

Thus, with this embodiment, by measuring and correcting the line width of the straight line drawn by each of the nozzles in the sub-scanning direction, the variation in volume of ink droplets and the variation in hitting position are appropriately correctable, and the volume of ink droplets is appropriately made uniform so as to be hit at an appropriate position. Consequently, the occurrence of stripe unevenness or the like is appropriately reducible. With this embodiment, it is therefore possible to appropriately bring printing quality into high quality image, leading to more appropriate printing.

On this occasion, by reducing the variation in volume of ink droplets or the like, the high quality printing can be carried out appropriately without the need for printing in the multi-pass mode. Alternatively, when printing is carried out in the multi-pass mode, the necessary number of passes is appropriately reducible. This embodiment is therefore capable of increasing printing velocity.

An increase in circuit scale is reducible by making the correction for the volume of ink droplets or the like with the use of a method of individually setting the effective voltages of the driving signals on a per-nozzle basis. This makes it possible to more appropriately make the correction while suppressing the increase in costs.

It is conceivable to make the correction for the volume of ink droplets and the like described above, for example, at shipment of the liquid ejection apparatus 10 (refer to FIG. 16) from a factory, and during manufacturing of the inkjet heads. It is also conceivable that a user makes the correction at a place where the liquid ejection apparatus 10 is used. In the configuration of the liquid ejection apparatus 10, a plurality of printing conditions (print modes) are settable, and it is conceivable to change the printing conditions and volume of ink droplets depending on the print mode. In this case, for example, a correction range and a correction value may be changed depending on the print mode.

Although the invention of the present application has been described with reference to the embodiments, the technical scope of the invention of the present application is not limited to the scope of the description of the above embodiments. It is apparent to those skilled in the art that a variety of changes or improvements are applicable to the above embodiments. It is apparent from the description of claims that any embodiment obtained by making such changes or improvements can also be included within the technical scope of the invention of the present application.

### INDUSTRIAL APPLICABILITY

The invention of the present application is suitably applicable to liquid ejection apparatuses.

1. A liquid ejection apparatus configured to eject liquid droplets by an inkjet technology, the liquid ejection apparatus comprising:
an ejection head, comprising:
a plurality of nozzles, configured to respectively eject liquid droplets by the inkjet technology, and
a plurality of driving elements, configured to cause liquid droplets to be respectively ejected from the respective nozzles;
a driving signal outputter, configured to output a driving signal for driving the driving elements;
an ejection nozzle setter, configured to set the nozzle that ejects liquid droplets by selecting the driving element that receives the driving signal; and
a timing setter, configured to set timing at which the driving element corresponding to the nozzle set by the ejection nozzle setter as the nozzle that ejects liquid droplets receives the driving signal,
wherein the ejection nozzle setter is capable of selecting, as the nozzle that ejects liquid droplets, a plurality of the nozzles that eject an identical volume of liquid droplets which is preset,
wherein the driving signal outputter outputs, in common, a voltage change signal being a signal whose voltage changes with passage of time, as at least a part of the driving signal, to the plurality of the nozzles that eject the identical volume of liquid droplets,
wherein the timing setter individually sets a time period during which the driving elements receive the voltage change signal, for each of the driving elements, and
wherein each of the nozzles ejects liquid droplets by the inkjet technology according to the driving signal in which a time period to receive the voltage change signal in the driving element corresponding to the nozzle is individually set.

2. The liquid ejection apparatus according to claim 1, wherein
each of the driving elements is a piezo element configured to be displaced according to the driving signal.

3. The liquid ejection apparatus according to claim 2, wherein
the driving signal outputter outputs, as at least a part of the driving signal,
a first pull signal that is a voltage signal causing the piezo element to be displaced so as to pull a liquid into an ink chamber of a preceding stage of the nozzle,
a push signal that is a voltage signal causing the piezo element to be displaced so as to push out the liquid pulled in according to the first pull signal, and
a second pull signal that is a signal causing the piezo element to be displaced so as to push back a part of the liquid pushed out of the nozzle according to the push signal,
wherein each of the driving elements causes liquid droplets to be ejected from the nozzle corresponding to the driving element by sequentially receiving the first pull signal, the push signal, and the second pull signal,
wherein the timing setter sets timing at which each of the driving elements receives the first pull signal, the push signal, and the second pull signal, and
wherein the voltage change signal is at least one of the first pull signal, the push signal, and the second pull signal.

4. The liquid ejection apparatus according to claim 1, further comprising:
a correction data storage, configured to store a correction data used for correction for an ejection property of the nozzles,
wherein the correction data storage stores, as the correction data, timing being preset correspondingly to the ejection property of the nozzle as timing at which the driving element receives the voltage change signal, in association with the nozzle requiring a correction for the ejection property, and
wherein the timing setter sets, based on the correction data, timing of supplying the voltage change signal to the driving element corresponding to the nozzle requiring the correction for the ejection property.

5. The liquid ejection apparatus according to claim 1, wherein
the voltage change signal is a signal repeated in a cycle which is preset, and a signal whose voltage gradually changes in one direction according to passage of time in the cycle.

6. The liquid ejection apparatus according to claim 1, wherein
the voltage change signal is a saw tooth shaped wave whose voltage changes in a saw tooth shape.

7. The liquid ejection apparatus according to claim 5, wherein
the voltage change signal is a signal repeated in a cycle which is preset, and
wherein the timing setter individually sets a time period during which each of the driving elements receives a signal in terms of the voltage change signal before and after polarity inversion, by inverting polarity of the voltage change signal in a middle of a cycle, and individually setting timing of inverting polarity for each of the driving elements.

8. An adjustment method for a liquid ejection apparatus configured to adjust ejection property of liquid droplets in the liquid ejection apparatus according to claim 1, the adjustment method for the liquid ejection apparatus comprising:
adjusting ejection property of liquid droplets respectively from the nozzles by individually setting, for each of the driving elements, a time period during which the driving element receives the voltage change signal.

9. The adjustment method for the liquid ejection apparatus according to claim 8, further comprising:
previously obtaining a nozzle property data indicating ejection property of each of the nozzles by previously measuring ejection property of each of the nozzles in a case of using the driving signal as a reference which is preset;
setting, as timing at which the driving element receives the voltage change signal, timing being set based on the nozzle property data, to the driving elements respectively corresponding to each of the nozzles; and
individually setting, for each of the driving elements, a time period during which the driving element receives the voltage change signal, based on timing being set based on the nozzle property data.

10. The adjustment method for the liquid ejection apparatus according to claim 9, wherein an operation of previously measuring ejection property of each of the nozzles in case of using the driving signal as the reference, comprises:
previously measuring ejection property of the nozzle by causing each of the nozzles to draw a straight line by using the driving signal as the reference, and measuring a line width of the straight line.

11. The adjustment method for the liquid ejection apparatus according to claim 8, further comprising:
adjusting ejection property of the nozzle in which the ejection property falls within a preset range; and
making a determination that the nozzle in which the ejection property is beyond a preset range is a defective nozzle.

12. A liquid ejection apparatus configured to eject liquid droplets by inkjet technology, the liquid ejection apparatus comprising:
an ejection head, comprising:
a plurality of nozzles, configured to respectively eject liquid droplets by the inkjet technology, and
a plurality of driving elements, configured to cause liquid droplets to be respectively ejected from the respective nozzles;
a driving signal outputter, configured to output a driving signal for driving the driving elements;
an ejection nozzle setter, configured to set the nozzle that ejects liquid droplets by selecting the driving element that receives the driving signal; and
an ejection property storage, configured to store ejection property of each of the nozzles,
wherein the driving signal outputter comprises:
a setting voltage outputter, configured to output a plurality of setting voltage signals that are a plurality of kinds of signals being set to voltages being different from each other; and
a selection voltage supplier, configured to supply, as the driving signal, any one of the setting voltage signal to the driving element corresponding to the nozzle that eject liquid droplets, at least partial timing of a time period during which the driving signal is supplied to the driving element, and
wherein the selection voltage supplier supplies, based on ejection property of the nozzle being stored in the ejection property storage, the setting voltage signal being previously associated with ejection property of the nozzle, to the driving elements respectively corresponding to the nozzles.

13. The liquid ejection apparatus according to claim 12, wherein
the ejection property storage stores ejection property of each of the nozzles by classifying the ejection property into one of n-classes which is preset where n is an integer of two or more,
wherein the setting voltage outputter outputs n-kinds of the setting voltage signals respectively associated with the n-classes, and
wherein the selection voltage supplier supplies the setting voltage signals being associated with the classes to the driving elements respectively corresponding to the nozzle, according to the class into which ejection property of each of the nozzles is being classified by the ejection property storage.

14. The liquid ejection apparatus according to claim 12, wherein
the setting voltage outputter outputs, as each of the setting voltage signals, fixed voltage signals being different from each other in voltage.

15. The liquid ejection apparatus according to claim 12, wherein
each of the driving element is a piezo element to be displaced according to the driving signal.

16. The liquid ejection apparatus according to claim 15, wherein
the driving signal outputter outputs, as at least a part of the driving signal,
a first pull signal that is a voltage signal causing the piezo element to be displaced so as to pull a liquid into an ink chamber of a preceding stage of the nozzle,
a push signal that is a voltage signal causing the piezo element to be displaced so as to push out liquid pulled in according to the first signal from the nozzle, and
a second pull signal that is a signal causing the piezo element to be displaced so as to push back part of the liquid pushed out of the nozzle according to the push signal,
wherein each of the driving elements causes liquid droplets to be ejected from the nozzle corresponding to the driving element by sequentially receiving the first pull signal, the push signal, and the second pull signal, and
wherein the selection voltage supplier supplies the setting voltage signal to the driving element as at least one of the first pull signal, the push signal, and the second pull signal.

17. An adjustment method for a liquid ejection apparatus configured to adjust ejection property of liquid droplets in the liquid ejection apparatus according to claim 12, the adjustment method for the liquid ejection apparatus comprising:
adjusting ejection property of liquid droplets respectively from the nozzles by individually setting, for each of the driving elements, the setting voltage signal supplied to each of the driving elements.

18. The adjustment method for the liquid ejection apparatus according to claim 17, further comprising:
previously measuring ejection property of each of the nozzles in a case of using the driving signal as a reference which is preset;
selecting one of the setting voltage signals according to a measured ejection property, with respect to the driving elements respectively corresponding to each of the nozzles; and
supplying the setting voltage signal selected according to the measured ejection property as at least a part of the driving signal.

19. The adjustment method for the liquid ejection apparatus according to claim 18, wherein an operation of previously measuring ejection property of each of the nozzles in a case of using the driving signal as the reference comprises:
previously measuring ejection property of the nozzle by causing each of the nozzles to draw a straight line by using the driving signal as the reference, and measuring a line width of the straight line.

20. The adjustment method for the liquid ejection apparatus according to claim 17, further comprising:
adjusting ejection property of the nozzle in which the ejection property falls within a preset range; and
making a determination that the nozzle in which the ejection property is beyond a preset range is a defective nozzle.
